(19) United States
(12) Patent Application Publication
(10) Pub. No.: US 2025/0264158 A1
(43) Pub. Date: Aug. 21, 2025

(54) SPRING DEFLECTING SHIFT FORK

(71) Applicant: Dana Heavy Vehicle Systems Group, LLC, Maumee, OH (US)

(72) Inventors: Kyle D. JOHNSON, Toledo, OH (US); Sakthikumar RATHAKRISHNAN, Perrysburg, OH (US); Nathan D. MANDERY, Perrysburg, OH (US)

(21) Appl. No.: 18/442,495

(22) Filed: Feb. 15, 2024

(51) Int. Cl. F16H 63/32; F16H 63/30

(52) U.S. Cl. CPC F16H 63/32; F16H 2063/3089; F16H 2063/321

(57) ABSTRACT

A shift fork assembly comprising: a clutch collar; a shift actuator collar positioned side by side to the clutch collar; a dowel inserted through the clutch collar and the shift actuator collar; and a C-shaped spring positioned over a first portion of the clutch collar and a second portion of the shift actuator collar, and the dowel being concentric to the C-shaped spring.

### TECHNICAL FIELD

Shift fork for use in a transmission.

### BACKGROUND AND SUMMARY

Vehicles, such as electrified vehicles, may have a transmission to switch gears of different ratios that produce different output torques and rotational speeds with the same input torque. The transmission may include clutch assemblies comprising clutches, such as synchronizers or dog clutches. The clutch assemblies may be actuated to selectively couple complementary gears via at least an actuator and a shifting/shift implement. Each of the clutch assemblies may be physically coupled to a shift fork. The shift fork may shiftingly couple a complementary clutch assembly to the shifting implement, such that actuation of the shifting implement may translate the shift fork and components of the clutch assembly in approximately the same direction the shifting implement is actuated. The shifting of a shift fork in a first direction may engage the clutch assembly, so an engaging component and an engagement component may rotationally couple, and rotational elements complementary to the engaging component and engagement component may rotationally couple. For example, the clutch assembly may engage and rotationally couple a first rotational element to a second rotational element, such as a shaft to a gear of a gearset. For an example, the shifting implement may be a shifting/shift rod. For another example, the shifting implement may be a shifting/shift screw.

Rigid shift forks may transfer resistive forces from a clutch assembly to a shifting implement and actuator. Likewise, certain clutches, such as dog clutches, may be prone to transferring higher quantities of resistive forces to other clutches during engagement. When engaging the clutch assembly at high speeds or at higher torques, the resistive forces transferred to the shifting implement and actuator may be greater than a threshold force. Resistive forces that are greater than the threshold force may result in degradation to the shifting implement and actuator, including acute or chronic degradation, such as permanent degradation. Resistive forces that are greater than the threshold force may result in misalignments of components included by the actuator assembly and the shift fork relative to the actuator assembly.

The inventors herein have recognized these and other issues with such systems and have come up with a way to at least partially solve them. As developed in one example, is a shift fork assembly comprising: a clutch collar; a shift actuator collar positioned side by side to the clutch collar; a dowel inserted through the clutch collar and the shift actuator collar; and a C-shaped spring positioned over a first portion of the clutch collar and a second portion of the shift actuator collar, and the dowel being concentric to the C-shaped spring.

The shift fork assembly may function as a rotational shift fork that has been separated. Separating the shift fork assembly into a first structure and a second structure, for example, may allow for a first structure to rotate independently of the second structure and vice versa. The independent rotation may reduce or prevent a force, such as torque, applied to the first structure from transferring to the second structure and vice versa. For example, the first clutch may be a dog clutch collar and the second structure may be a shift actuator collar, where the dog clutch collar is physically coupled to a dog of a dog clutch and the shift actuator collar is coupled to the shift actuator such as to be shifted therein. The separation of the dog clutch collar and shift actuator collar may allow the shift actuator and dog clutch to be separated, such that the dog clutch may be engaged via shift actuator and no torque may be transferred between the two. The two structures of the shift fork assembly may be constrained, such as to rotate about a common axis. A “C” shaped spring or other spring may connect, be positioned about, and be in surface sharing contact with the first structure and the second structure. When fit to the first structure and second structure, the spring may apply a counter torque or another counter force via a spring force to the resistance torque or other resistance forces transferred to the first structures. Likewise, the spring may couple the first structure and second structure allowing the shift fork assembly to shift as a 1-piece shift fork. However, the first structure and second structure may move to change the shape of the spring elastically, via expansion and compression, if a force greater than a threshold is provided. For example, the shift fork assembly may be blocked. Resistive forces caused by the blocking of the shift fork may elastically deform the spring and/or the position of the first structure from the second structure or vice versa. The elastic shape change and the counter torque of the spring and the independent rotation of the second structure from the first structure may reduce degradation to components. The second structure may rotate and the spring may absorb and counter the resistive forces transferred from the first structure without degrading other components until the shift fork assembly is no longer blocked from movement by dog teeth. This device may allow for a simpler actuator design. Linear shift forks may use springs to pre-load in a first direction or a second direction, where the first direction may be opposite to the second direction. The “C”-shaped spring or other spring design about the first and second structure allows a compact solution that is pre-loaded in both directions.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example schematic of a vehicle which may include the transmission of the present disclosure.

FIG. 2 shows an example schematic of a gear assembly of the transmission which may include clutches and shift forks of the present disclosure.

FIG. 3 shows a first view that is a first side view of a shift fork assembly.

FIG. 4 shows a second view that is a second side view of the shift fork assembly and the angles of rotation for components of the shift fork assembly.

FIG. 5A shows a third view that is a third side view of the shift fork assembly, showing a spring is coupled to the shift fork assembly.

FIG. 5B shows a fourth view of the shift fork assembly, where the spring is not coupled to the shift fork assembly.

FIG. 6 shows a fifth view that is a first side view of the spring.

FIG. 7 shows a sixth view that is a second side view of the spring.

FIG. 8 shows a seventh view that is a first side view of an assembly that includes an actuator assembly, a clutch assembly, and the shift fork assembly.

FIG. 9 shows an eighth view that is a sectional view of the assembly with a shaft and a plurality of gears.

FIG. 10 shows a ninth view that is a side view of the actuator assembly.

### DETAILED DESCRIPTION

The following description relates to a shift fork assembly that includes a first structure and a second structure. The shift fork assembly may be used in a transmission of a vehicle, such as an electrified vehicle, such as an all-electric vehicle (EV) or a hybrid vehicle with multiple inputs of torque. When shifted, the shift fork assembly may shift between gear sets and ratios of output speed for the transmission. Both the first structure and the second structure may be shifted to the same position by a shift actuator, such that the shift fork assembly may act as a shift fork. The shift fork assembly may include a rotational shift fork and/or be a rotational shift fork assembly for a first example. The first structure may be a structure that physically and/or shiftingly couples to a component of a clutch or clutch assembly, such as a clutch collar. The second structure may be a component that physically and/or shiftingly couples to an actuator or an actuator assembly, where the second structure may physically or shiftingly couple to a component of the actuator assembly shifted via the actuator. The second structure may therein be an actuator collar, such as a shift actuator collar. As the shift fork assembly is actuated, components of a clutch may be actuated to rotate or slide with the friction torque assembly. For example, an engaging component may be shifting coupled to the first structure, such that the engaging component may shifted with the first structure.

The first structure and second structure may be separated by a gap and an interface. The interface may have a clearance allowing for the rotation of the second structure from the first structure or vice versa. The first structures and second structure may be centered about a common axis. A dowel may be inserted through the first structure and second structure, such as through a first sleeve of the first structure and a second sleeve of the second structure. The first and second sleeves may include a first fit and a second fit that may receive the dowel. The dowel may be centered on the common axis, such that the first structure and second structure may pivot about the dowel. A spring may be positioned about portions of the first structure and the second structure, and across the interface. The spring may be “C” shaped and may be referred to as C-shaped spring. The C-shaped spring may be loaded externally to the assembly. The C-shaped spring may be positioned about the first sleeve and the second sleeve. The C-shaped spring may limit the rotation of the components to an angle of a first maximum and an angle of a second maximum. The first maximum angle may be in a first direction from a common line perpendicular to the common axis. The second angle may be a second direction from a common line perpendicular to the common axis. The common line may divide the first structure and second structures approximately symmetrically. When the first and second structures are symmetrically divided by the common line, the first structure may be aligned with the second structure and vice versa.

For an example, the first structure may be a coupled to the engaging component in the manner described above via a plurality coupling, such as engagements, such as shift pads. The couplings may be in surface sharing contact with a component of the engaging component, such as a sleeve. Likewise, the couplings may be fastened to the shift fork assembly via a fastening component. When fastened, the couplings may physically couple the shift fork assembly, and the couplings may shiftingly couple the shift fork assembly to an engaging component. The couplings may fasten to the first component. As a clutch collar, the first component may couple to an engaging component of a clutch or clutch assembly, such as a dog. When coupled to a dog, the first structure may be a dog clutch collar. As a clutch collar, the second structure may be or have features positioned about a clutch. The second structure may comprise a plurality of arms, such as at least two arms. The arms may be positioned about an engaging component of a clutch. Each of the sleeve couplings may be fastened to an arm of the first structure.

The second structure may be coupled to the actuator assembly via a plurality of fasteners. For example, the second structure may physically couple to a shaft and a connector of the actuator assembly via the fasteners. The second structures may comprise a plurality of arms, such as at least two arms. The arms may be positioned about components of the actuator assembly. Each of the fasteners may be fastened to an arm of the second structure, such as at a lobe or another feature of the arm.

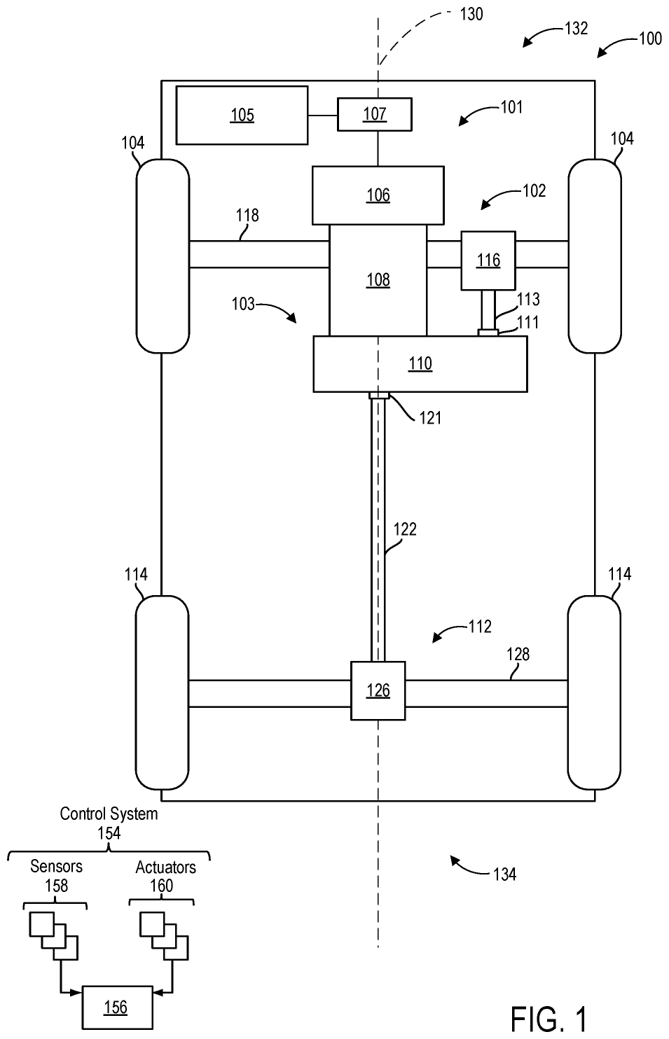

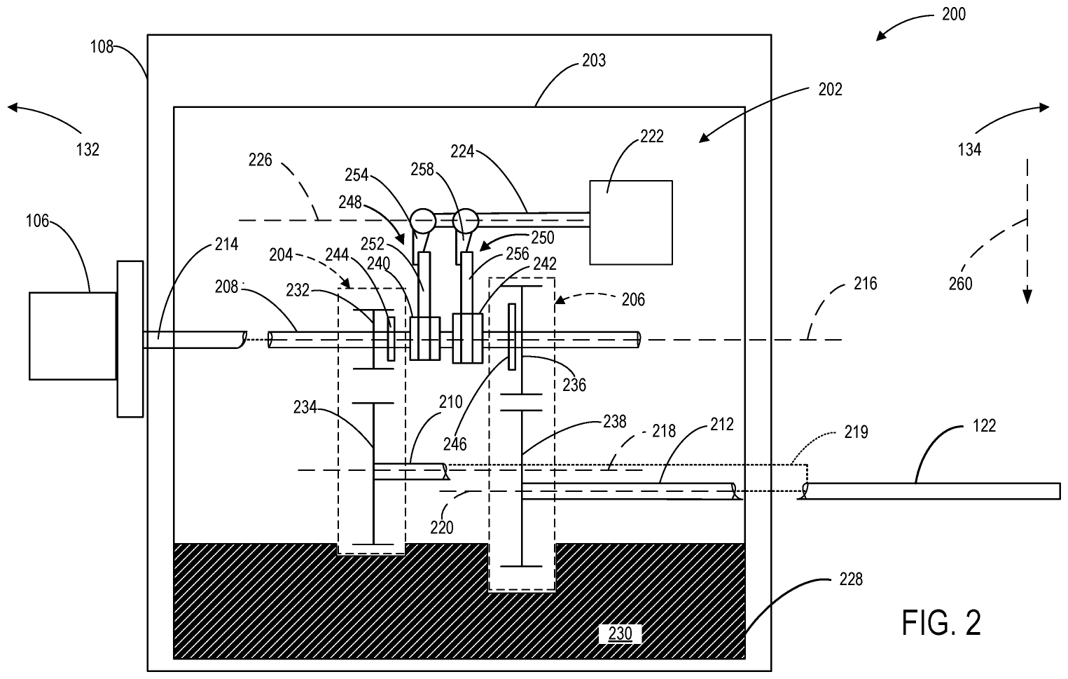

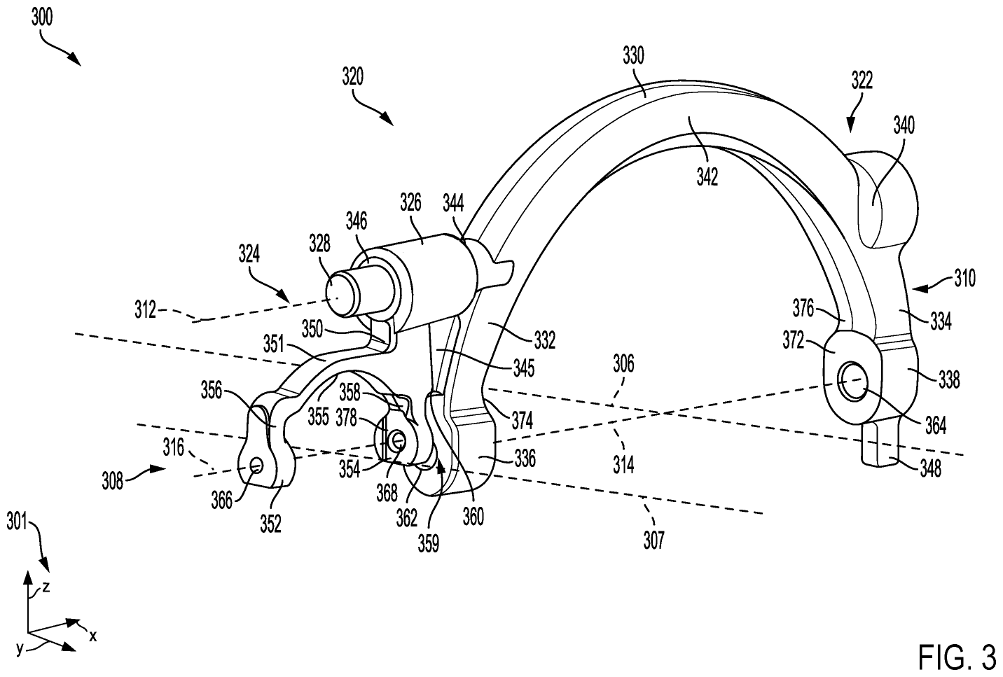

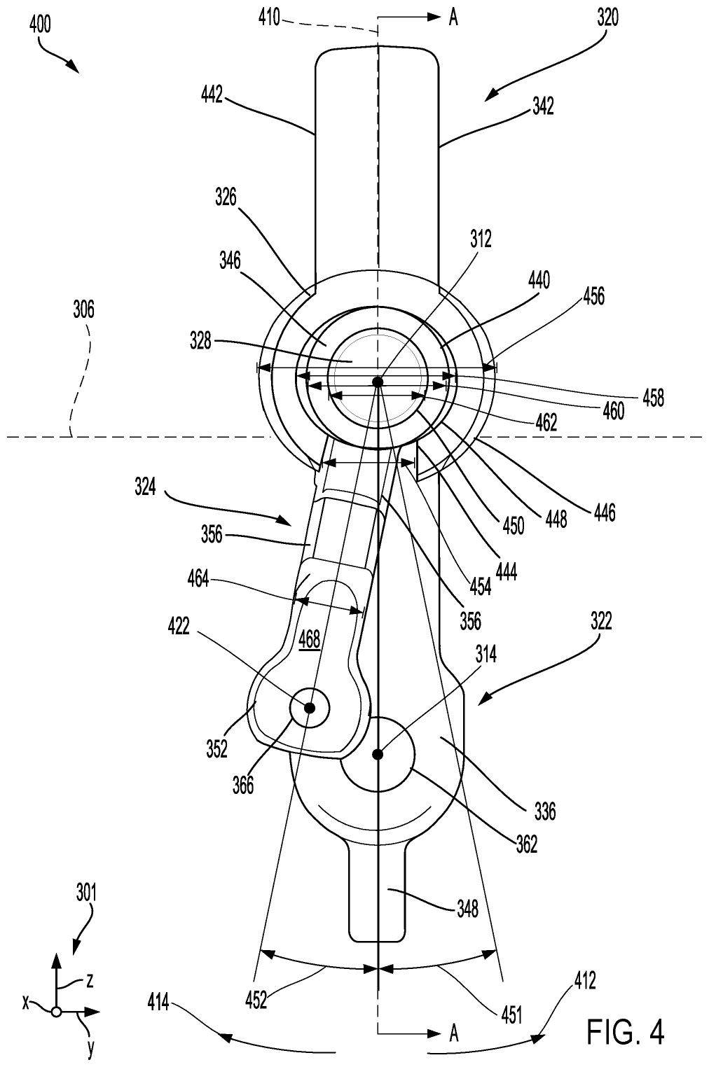

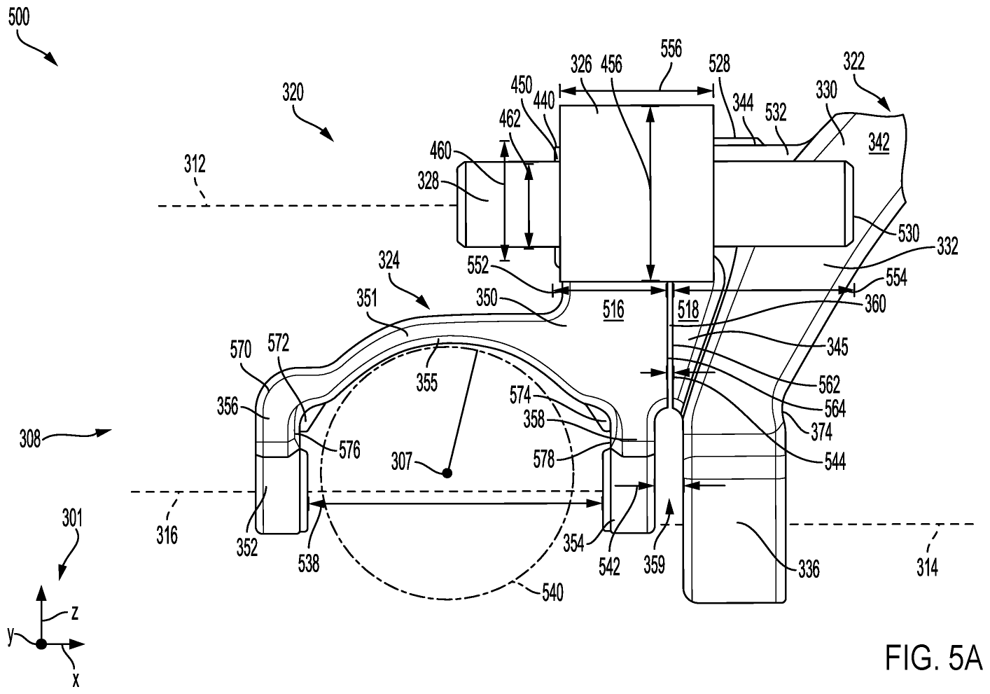

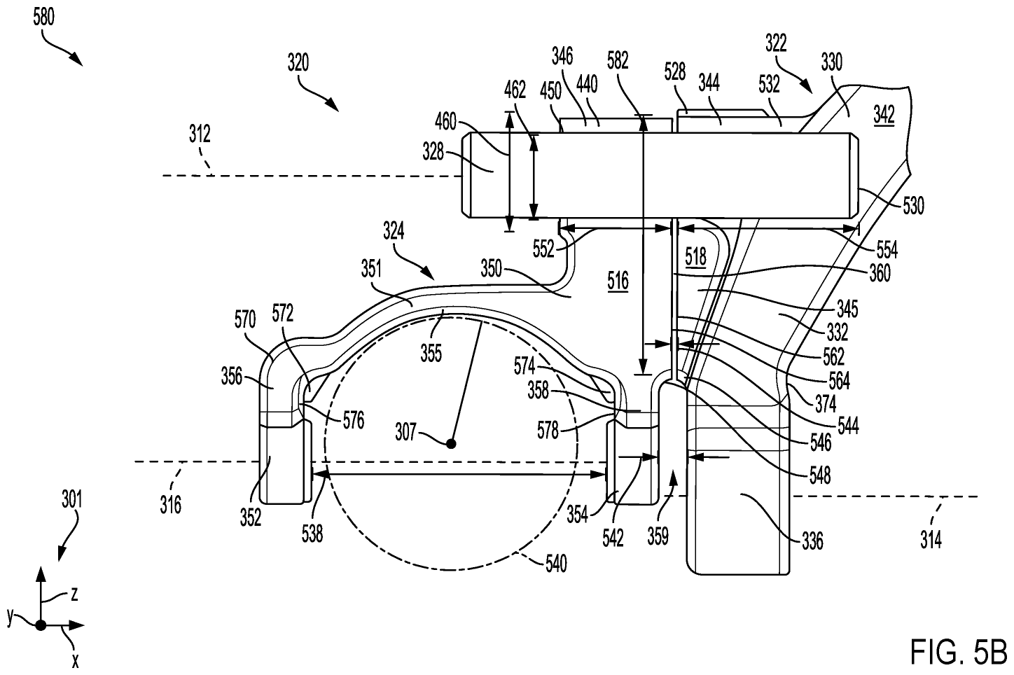

FIG. 1 shows an example schematic of a vehicle which may include the transmission of the present disclosure. FIG. 2 shows an example schematic of a gear assembly of the transmission which may include clutches and shift forks of the present disclosure. FIG. 3 shows a first view that is a first side view of a shift fork assembly. The shift fork assembly of FIG. 3 may be a shift fork assembly of the present disclosure, where the shift fork assembly includes two separate structures that may rotate independently of one another. A first structure may be a clutch collar and a second structure may be an actuator collar. A spring may be positioned about the first structure and second structure. FIG. 4 shows as second view that is a second side view of the shift fork assembly and the angles of rotation for components of the shift fork assembly. The angles of rotation of FIG. 4 may be the angle of rotation of the second structure about a dowel relative to the first structure. FIG. 5A shows a third view that is a third side view of the shift fork assembly, showing a spring is coupled to the shift fork assembly. FIG. 5B shows a fourth view of the shift fork assembly, where the spring is not coupled to the shift fork assembly. FIGS. 5A-5B show dimensions of the second structure.

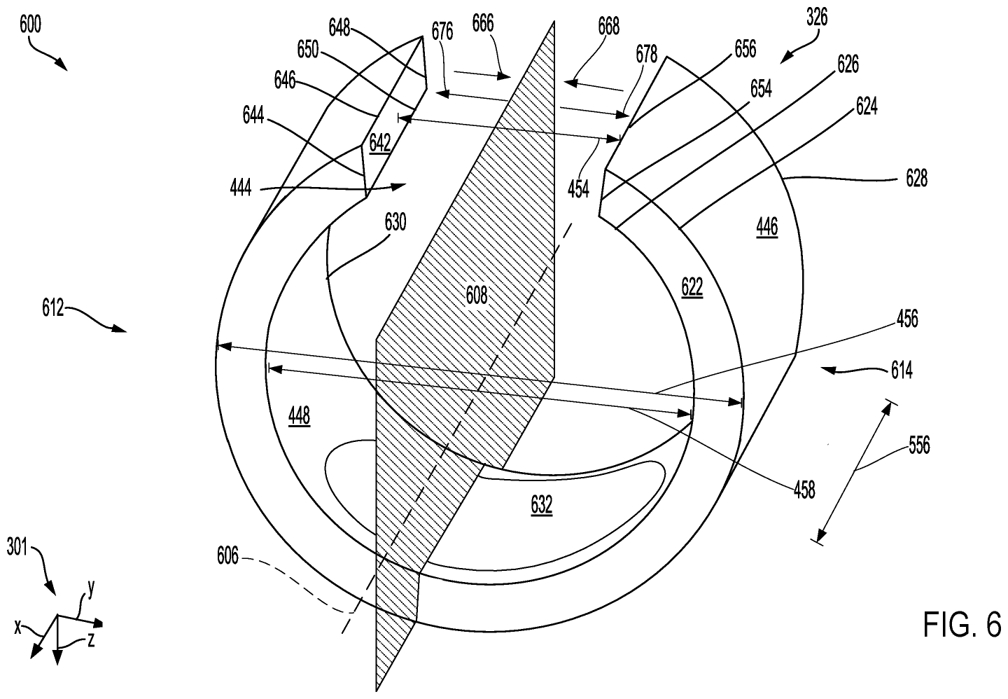

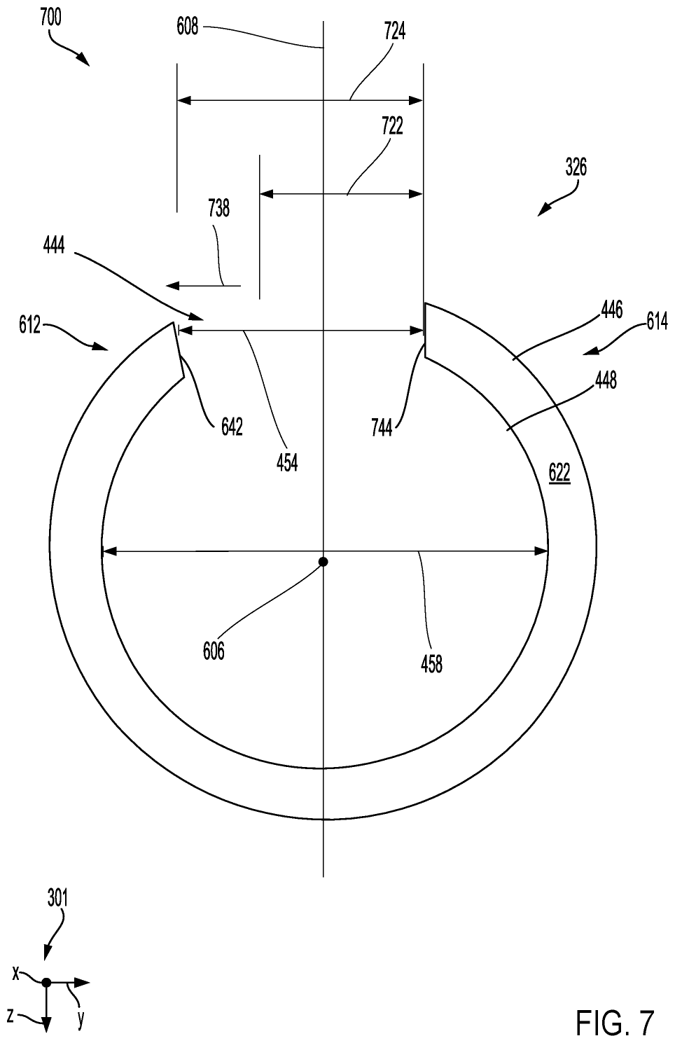

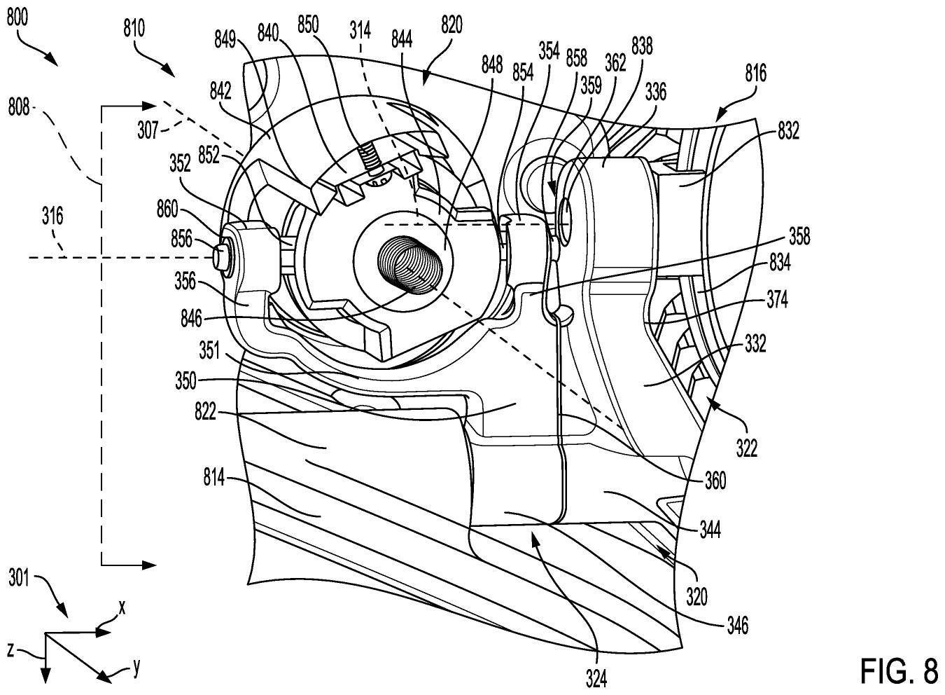

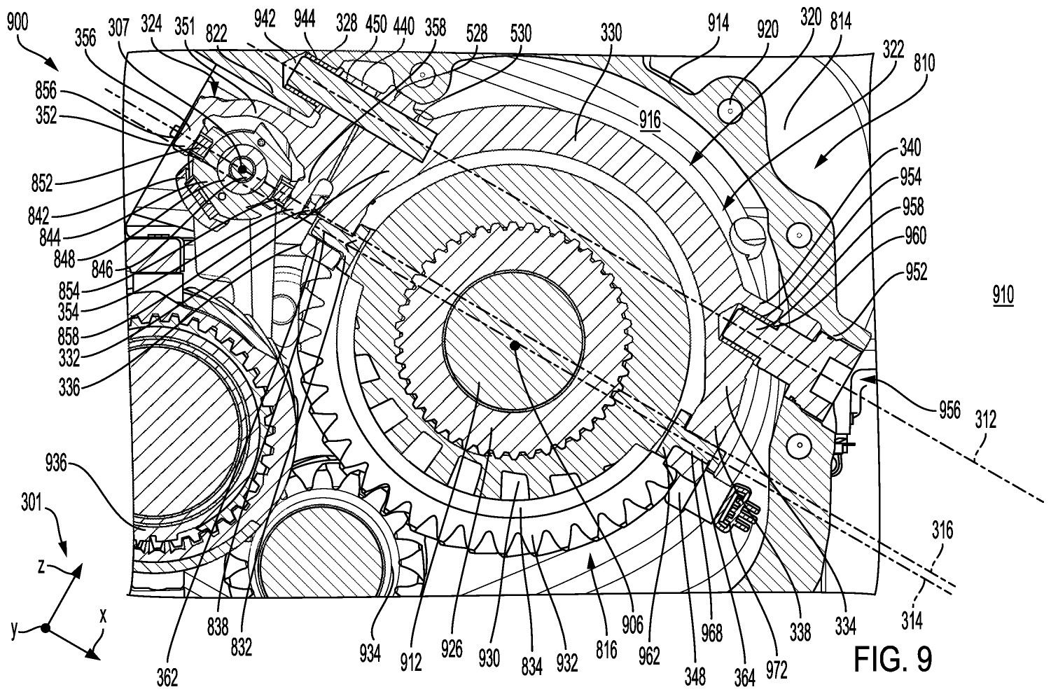

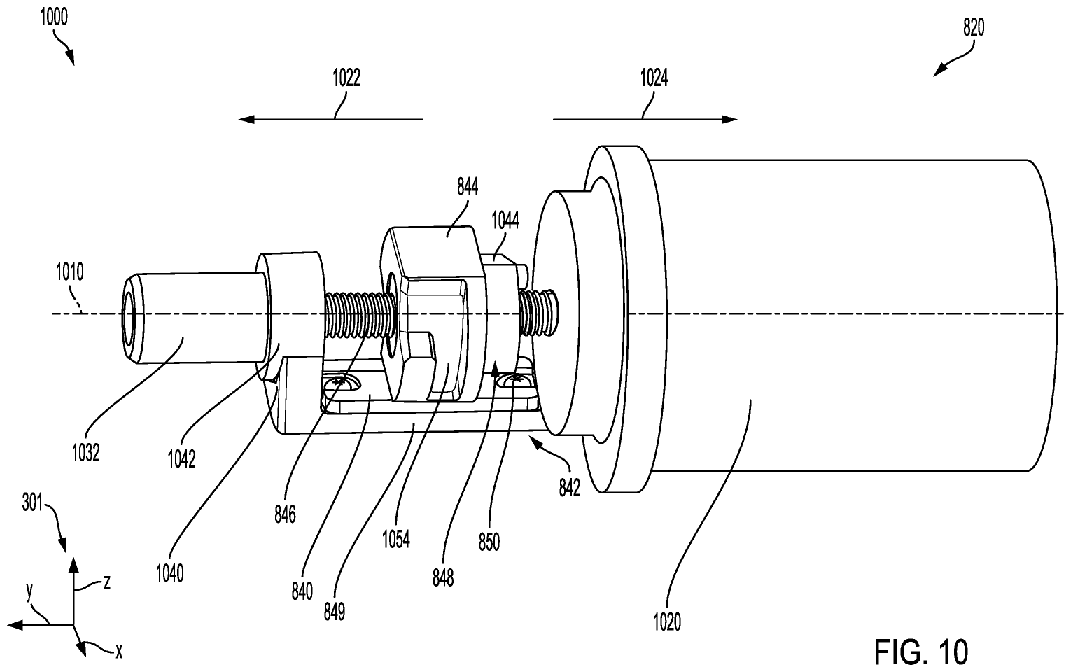

FIG. 6 shows a fifth view that is a first side view of the spring. FIG. 7 shows a sixth view that is a second side view of the spring. In FIGS. 6-7 the spring is shown separate from other components of the shift fork assembly of FIGS. 3-5A. The spring is a C-shaped spring and may be the spring shown in FIGS. 3-5A. FIG. 8 shows a seventh view that is a first side view of an assembly that includes an actuator assembly, a clutch assembly, and the shift fork assembly. In FIG. 8 the actuator assembly may be coupled to the shift fork assembly via the second structure. In FIG. 8 the clutch assembly may be coupled to the shift fork assembly via the first structure. FIG. 9 shows an eighth view that is a sectional view of the assembly with a shaft and a plurality of gears. The shaft may selectively couple to at least one of the gears via the clutch assembly. FIG. 10 shows a ninth view that is a side view of the actuator assembly.

It is also to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

FIGS. 1-2 shows schematics of an example configuration with relative positioning of the various components. FIGS. 3-8 show example configurations with approximate position. FIGS. 3-8 are shown approximately to scale; though other relative dimensions may be used. As used herein, the terms “approximately” is construed to mean plus or minus five percent of the range unless otherwise specified.

Further, FIGS. 1-8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

Features described as longitudinal may be approximately parallel with an axis that is longitudinal. A lateral axis may be normal to the longitudinal axis. Features described as lateral may be approximately parallel with the lateral axis and normal to the longitudinal axis.

Turning now to FIG. 1, a vehicle 100 is shown comprising a powertrain 101 and a drivetrain 103. The vehicle 100 may have a front end 132 and a rear end 134, located on opposite sides of vehicle 100. Features of the vehicle 100 referred to as being located near the front may be closest to the front end 132 compared to the rear end 134. Features of the vehicle 100 referred to as being located near the rear may be closest to the rear end 134 compared to the front end 132. The powertrain 101 comprises a prime mover 106 and a transmission 108. The prime mover 106 may be an internal combustion engine (ICE) or an electric machine, for example, and is operated to provide rotary power to the transmission 108. Electric machines may include electric motors and electric motor/generators. The transmission 108 may be any type of transmission, such as a manual transmission, an automatic transmission, or a continuously variable transmission.

The transmission 108 receives the rotary power produced by the prime mover 106 as an input and outputs rotary power to the drivetrain 103 in accordance with a selected gear or setting. Additionally, there may be other movers in the vehicle besides prime mover 106, such as if vehicle 100 is a hybrid. If the prime mover 106 is an ICE there may be at least a second mover with an input to the transmission 108, wherein the second mover may be an electric machine such as an electric motor. In one example, if there are a single or plurality of second movers in addition to the prime mover 106, the vehicle 100 may be a hybrid vehicle, wherein there are multiple torque inputs to the transmission 108.

The vehicle 100 may have a longitudinal axis 130. The powertrain 101 and drivetrain 103 may have a length parallel with the longitudinal axis 130.

The prime mover 106 may be powered via energy from an energy storage device 105. In one example, the energy storage device 105 is a battery configured to store electrical energy. An inverter 107 may be arranged between the energy storage device 105 and the prime mover 106 and configured to adjust direct current (DC) to alternating current (AC). The inverter 107 may include a variety of components and circuitry with thermal demands that effect an efficiency of the inverter.

The vehicle 100 may be a commercial vehicle, light, medium, or heavy duty vehicle, a passenger vehicle, an off-highway vehicle, and/or sport utility vehicle. Additionally or alternatively, the vehicle 100 and/or one or more of its components may be in industrial, locomotive, military, agricultural, and/or aerospace applications. In one example, the vehicle 100 is an all-electric vehicle or a vehicle with all-electric modes of operation, such as a plug-in hybrid vehicle. As such, the prime mover 106 is an electric machine. In one example, the prime mover 106 is an electric motor/generator.

In some examples, such as shown in FIG. 1, the drivetrain 103 includes a first axle assembly 102 and a second axle assembly 112. The first axle assembly 102 may be configured to drive a first set of wheels 104, and the second axle assembly 112 may be configured to drive a second set of wheels 114. In one example, the first axle assembly 102 is arranged near a front of the vehicle 100 and thereby comprises a front axle, and the second axle assembly 112 is arranged near a rear of the vehicle 100 and thereby comprises a rear axle. The drivetrain 103 is shown in a four-wheel drive configuration, although other configurations are possible. For example, the drivetrain 103 may include a rear-wheel drive, a front-wheel drive, or an all-wheel drive configuration. Further, the drivetrain 103 may include one or more tandem axle assemblies. As such, the drivetrain 103 may have other configurations without departing from the scope of this disclosure, and the configuration shown in FIG. 1 is provided for illustration, not limitation. Further, the vehicle 100 may include additional wheels that are not coupled to the drivetrain 103.

In some four-wheel drive configurations, such as shown in FIG. 1, the drivetrain 103 includes a transfer case 110 configured to receive rotary power output by the transmission 108. A first driveshaft 113 is drivingly coupled to a first output 111 of the transfer case 110, while a second driveshaft 122 is drivingly coupled to a second output 121 of the transfer case 110. The first driveshaft 113 (e.g., a front driveshaft) transmits rotary power from the transfer case 110 to a first differential 116 of the first axle assembly 102 to drive the first set of wheels 104, while the second driveshaft 122 (e.g., a rear driveshaft) transmits the rotary power from the transfer case 110 to a second differential 126 of the second axle assembly 112 to drive the second set of wheels 114. For example, the first differential 116 is drivingly coupled to a first set of axle shafts 118 coupled to the first set of wheels 104, and the second differential 126 is drivingly coupled to a second set of axle shafts 128 coupled to the second set of wheels 114. It may be appreciated that each of the first set of axle shafts 118 and the second set of axle shafts 128 may be positioned in a housing. The first driveshaft 113 and second driveshaft 122 may be positioned to extend in parallel with the longitudinal axis 130. For an example of a configuration of vehicle 100, the second driveshaft 122 may be centered about the longitudinal axis 130.

The first differential 116 may supply a FWD in some capacity to vehicle 100, as part of rotary power transferred via the first driveshaft 113. Likewise, the second differential 126 may supply a RWD to vehicle 100, as part of the rotary power transferred via the second driveshaft 122. The first differential 116 and the second differential 126 may supply a FWD and RWD, respectively, as part of an AWD mode for vehicle 100.

Adjustment of the drivetrain 103 between the various modes as well as control of operations within each mode may be executed based on a vehicle control system 154, including a controller 156. Controller 156 may be a microcomputer, including elements such as a microprocessor unit, input/output ports, an electronic storage medium for executable programs and calibration values, e.g., a read-only memory chip, random access memory, keep alive memory, and a data bus. The storage medium can be programmed with computer readable data representing instructions executable by a processor for performing the methods described below as well as other variants that are anticipated but not specifically listed. In one example, controller 156 may be a powertrain control module (PCM).

Controller 156 may receive various signals from sensors 158 coupled to various regions of vehicle 100. For example, the sensors 158 may include sensors at the prime mover 106 or another mover to measure mover speed and mover temperature, a pedal position sensor to detect a depression of an operator-actuated pedal, such as an accelerator pedal or a brake pedal, speed sensors at the first and second set of wheels 104, 114, etc. Vehicle acceleration is directly proportional to accelerator pedal position, for example, degree of depression. Upon receiving the signals from the various sensors 158 of FIG. 1, controller 156 processes the received signals, and employs various actuators 160 of vehicle 100 to adjust drive train operations based on the received signals and instructions stored on the memory of controller 156. For example, controller 156 may receive an indication of depression of the brake pedal, signaling a desire for decreased vehicle speed. In response, the controller 156 may command operations, such as shifting gear modes of the transmission 108. Alternatively, the gear modes of the transmission 108 may be shifted manually, such as if the transmission 108 is a manual transmission.

In some examples, additionally or alternatively, the vehicle 100 may be a hybrid vehicle including both an engine, such as an ICE, and an electric machine each configured to supply power to one or more of the first axle assembly 102 and the second axle assembly 112. For example, one or both of the first axle assembly 102 and the second axle assembly 112 may be driven via power originating from the engine in a first operating mode where the electric machine is not operated to provide power (e.g., an engine-only mode), via power originating from the electric machine in a second operating mode where the engine is not operated to provide power (e.g., an electric-only mode), and via power originating from both the engine and the electric machine in a third operating mode (e.g., an electric assist mode). As another example, one or both of the first axle assembly 102 and the second axle assembly 112 may be an electric axle assembly configured to be driven by an integrated electric machine.

In some embodiments, additionally or alternatively, the transmission 108 may be a first transmission, further comprising a second transmission arranged on the second set of axle shafts 128. Herein, the transmission 108 may be interchangeably referred to as a gearbox.

Turning to FIG. 2, a schematic 200 of the transmission 108 and gear enclosure 203 is illustrated with reference to FIG. 1 is shown. The gear enclosure 203 may be enclosed by and be comprised of a housing of the transmission 108. In one example, the gear enclosure 203 contains a gear assembly 202. The gearbox (e.g., the transmission 108) may be a multi-stage reduction gearbox with the gear assembly 202 acting as a system of a plurality of reduction sets. The gear assembly 202 may be formed of at least two reduction sets that may reduce the rotational speed (e.g., rotation per minute (RPM)) and increase the torque. The reduction sets may be referred to herein as stages. The stages may be gearsets. There may be a first stage 204 and second stage 206. The first stage 204 and second stage 206 may comprise gears, such as fixed gears.

As an example, the enclosure 203 of the transmission 108 may contain a first shaft 208, a second shaft 210, and a third shaft 212. The first stage 204 may be supported by the first shaft 208 and the second shaft 210. The second stage 206 may be supported by the first shaft 208 and the third shaft 212. The first shaft 208 may act as an input to the first stage 204 and second stage 206. The second shaft 210 may act as an output for the first stage 204. The third shaft 212 may act as an output for the second stage 206. The first stage 204 may drivingly couple the first shaft 208 to the second shaft 210. The second stage 206 may drivingly couple first shaft 208 to the third shaft 212. The first shaft 208 may be centered on a first axis 216. The second shaft 210 may be centered on a second axis 218. The third shaft 212 may be centered on a third axis 220. The first axis 216, second axis 218, and third axis 220 may be parallel with one another. The first stage 204 may traverse the first axis 216 to the second axis 218. The second stage 206 may traverse the first axis 216 to the third axis 220. The first shaft 208 may drivingly couple a first input shaft to gear assembly 202. For the example shown in schematic 200, the first input shaft may be an output shaft 214 of the prime mover 106. The output shaft 214 may be referred to herein as the prime mover output shaft 214. For this example, the prime mover 106 may be a first electric machine, such as a first electric motor. Shafts and other components that may be drivingly coupled but not directly contacting may be represented by dotted lines 219.

However, other configurations of the gearbox are possible. For example, the first input shaft may be a shaft drivingly coupled to output shaft 214 or the output of another reduction set. Additionally, for other configurations, there may be only a single shaft, such as second shaft 210, that may be selectively and drivingly coupled to the first shaft 208 via reduction ratios. For example, the first stage 204 and second stage 206 may selectively and drivingly couple the first shaft 208 to the second shaft 210.

The second shaft 210 and third shaft 212 may be drivingly coupled to a first output shaft. For the example shown in schematic 200, the first output shaft may be a drive shaft, such as the second driveshaft 122. However, other configurations of the gear assembly 202 and enclosure 203 are possible. For example, the first output shaft may be a shaft drivingly coupled to a drive shaft, such as the second driveshaft 122, or to another reduction set. Additionally, for other examples, the second shaft 210 and/or third shaft 212 may be drivingly coupled to separate output shafts. For example, the second shaft 210 may be drivingly coupled a first output shaft, such as the first driveshaft 113 of FIG. 3. For this example, the third shaft 212 may be drivingly coupled to a second output shaft, such as the second driveshaft 122. Additionally, for other examples, the second shaft 210 and/or third shaft 212 may be output shafts.

An actuator 222 may be used to selectively and drivingly couple the first stage 204 or second stage 206 to the first shaft 208. The actuator 222 may be drivingly coupled to a shifting implement 224. The actuator 222 may be mounted to the transmission 108 or a component of the transmission 108, such as the walls and surfaces of the enclosure 203. For one example, the actuator may be mounted via fastening by a plurality of fasteners, such as screws. For another example, the actuator may be fit to a recess or void of surfaces and material of the transmission 108. The actuator 222 may be one of the actuators 160 of FIG. 1.

As an example, the actuator 222 may advance the shifting implement 224 along a fourth axis 226, such as via translation. The actuator 222 may advance the shifting implement 224 via a screwing motion, spinning the shifting implement 224 about the fourth axis 226. When translated in a first direction, such as toward the front end 132, the shifting implement 224 may drivingly couple the first stage 204 to the first shaft 208. When translated in a second direction, such as toward the rear end 134, the shifting implement 224 may drivingly couple the second stage 206 to the first shaft 208. The shifting implement 224 may be guided by the housing of the transmission 108 and/or enclosure 203. For an example, the actuator 222 may be a shift lever.

As another example, the actuator 222 may be a rotational shifting actuator. As a rotational shifting actuator the actuator 222 may pivot the shifting implement 224 about the fourth axis 226. The actuator 222 may pivot the shifting implement 224 via a screwing motion, spinning the shifting implement 224 about the fourth axis 226. When pivoted in a first direction, such as toward the first axis 216, the shifting implement 224 may drivingly couple the first stage 204 to the first axis 216. When pivoted in a second direction, such as away from the first axis 216, the shifting implement 224 may couple the second stage 206 to the first shaft 208.

The enclosure 203 may form a sump 228 for work fluid 230. The work fluid 230 may be a lubricant, such as oil. The gears of the first stage 204 and second stage 206 may be lubricated by the work fluid 230 via splashing. The sump 228 may be located below the assembly 202, such that work fluid 230 may be returned to the sump 228 via the force of gravity 260 and lowest gear of the first stage 204 and second stage 206 may dip into sump 228. Dipping of a gear into the sump 228 may coat the teeth and other components with work fluid 230. When coated with work fluid 230, a gear of the first stage 204 and a gear in second stage 206 may carry and coat the teeth of other gears in mesh, therein lubricating the other gears of the first stage 204 and second stage 206. The splashing of lubricant from the gears may coat other components of the assembly 202, such as portions of the first shaft 208, second shaft 210, and third shaft 212. After lubricating the gears of the first stage 204 and second stage 206, work fluid 230 may be returned to the sump 228 via splashing and dripping. However, it is to be appreciated, that the method of lubrication of gears of the first stage 204 and the second stage 206 may be non-limiting. For example, additionally or alternatively, gears of the first stage 204 and the second stage 206 may be lubricated via spraying. It is also to be appreciated, that the positioning of the gears the first stage 204 and the second stage 206 relative to the direction of gravity 260 and the sump 228 may be non-limiting. For another example, there may be no gears of the first stage 204 or second stage 206 that dip into the sump 228. Likewise, for this or another example the gears of the first stage 204 and second stage 206 may be level such as to not have a gear above or below with respect to the direction of gravity 260.

The first stage 204 and second stage 206 may be formed of a plurality of gears. Both the first stage 204 and second stage 206 may each be formed from at least two gears. For an example, the first stage 204 may be formed of a first gear 232 and a second gear 234. For this example, the second stage 206 may be formed of a third gear 236 and a fourth gear 238.

There may be a plurality of arms and engagements used by the shifting implement 224 and actuator 222 to drivingly couple reduction sets. There may be at least one arm and two engagements drivingly coupled to the shifting implement 224 to select reduction sets. The number of arms and engagements drivingly coupled to the shifting implement 224 may be dependent on the number of sets to engage. The first stage 204 may be drivingly coupled to the first shaft 208 via a first engaging component 240 and first coupling 244. Likewise, the second stage 206 may be drivingly coupled to the first shaft 208 via a second engaging component 242 and second coupling 246. The first engaging component 240 and second engaging component 242 may be drivingly coupled to the shifting implement 224 via a first arm 248 and second arm 250, respectively. The first arm 248 and the second arm 250 may each include a plurality of components and structures that may be coupled such as to function as an arm.

The first coupling 244 and second coupling 246 may be drivingly coupled to the first gear 232 and second gear 234, respectively. The first engaging component 240 and the first coupling 244 may form a clutch. The second engaging component 242 and the second coupling 246 may form a clutch. In examples where the clutches are dog clutches, the first engaging component 240 and the second engaging component 242 may each be or include dog gears.

Schematic 200 shows a single shifting implement, shifting implement 224, that may be shifted by the actuator 222. The shifting implement 224 may physical couple to and actuate the first arm 248 and the second arm 250. For an example, the shifting implement 224 may be screw, e.g., a shift screw, and the actuator 222 may be a motor. As a shift screw, the shifting implement 224 may be a ball screw. However, it is to be appreciated that the shifting implement 224 may include other types of shifting implements besides screws, and the shifting implement 224 may be a shifting/shift rod or a shaft. It is to be appreciated that the schematic 200 is non-limiting and there may be a plurality of shifting implements and actuators. For example, there may be a plurality of shifting implements shifted by actuator 222. For another example, there may be a plurality of shifting implements wherein each shifting implement is shifted by an actuator specifically coupled to each shifting implement. For these examples, each shifting implement may be specific to an arm, such as the first or second arm 248, 250, that may be used to actuate engagements, such as the first or second engaging component 240, 242, respectively.

The first arm 248 may include a first collar 252 and a second collar 254. The second arm 250 may include a third collar 256 and a fourth collar 258. The first collar 252 and third collar 256 may each be or include clutch collars, such as dog clutch collars, where the first collar 252 and third collar 256 may shiftingly couple to components of a clutch, such as engaging components. The first collar 252 may shiftingly couple to the first engaging component 240. The third collar 256 may shiftingly couple to the second engaging component 242. The second collar 254 and fourth collar 258 may be actuator collars that may shiftingly couple to the shift actuator 222. The second collar 254 and fourth collar 258 may each be physically coupled to a component shifted, pivoted, or rotated by the actuator 222, such as the shifting implement 224.

A set of reference axes 301 are provided for comparison between views shown in FIGS. 3-7. The reference axes 301 indicate a y-axis, an x-axis, and a z-axis. In one example, the z-axis may be parallel with a direction of gravity and the x-y plane may be parallel with a horizontal plane a shift fork assembly 320 may rest upon. When referencing direction, positive may refer to in the direction of the arrow of the y-axis, x-axis, and z-axis and negative may refer to in the opposite direction of the arrow of the y-axis, x-axis, and z-axis. A filled circle may represent an arrow and axis facing toward, or positive to, a view. An unfilled circle may represent an arrow and an axis facing away, or negative to, a view.

Turning to FIG. 3, it shows a first view 300 of a shift fork assembly 320. The first view 300 is a first side view of the shift fork assembly 320.

The first view 300 shows the shift fork assembly 320 positioned about a first axis 306 and a second axis 307. The shift fork assembly 320 may have a first side 308 and a second side 310. The first side 308 is opposite to the second side 310. The first and second axes 306, 307 may be longitudinal axes. The first and second axes 306, 307 may be shift axes that the structures included by the shift fork assembly 320 may shift in a first direction or second direction. The first direction is opposite to the second direction, and both the first and second directions are parallel with the first and second axes 306, 307.

The shift fork assembly 320 may also be positioned about a third axis 312, a fourth axis 314, and a fifth axis 316. The third axis 312, the fourth axis 314, and the fifth axis 316 may be parallel. The third axis 312, the fourth axis 314, and the fifth axis 316 may be lateral axes. Components and features of the shift fork assembly 320 may be centered about the third axis 312, fourth axis 314, and/or fifth axis 316.

The shift fork assembly 320 is an assembly of structures that may collectively function as a shift fork. The shift fork assembly 320 may be a configuration of the first arm 248 or second arm 250 of FIG. 2. The shift fork assembly 320 includes a first structure 322 and a second structure 324. The first structure 322 and second structure 324 may be two parts, a first part and a second part respectively, where each of the parts are separated. The first structure 322 and second structure 324 may be positioned side by side. The first structure 322 may be separated from the second structure 324 at a first gap 359 a second gap 360. The volumes of the first gap 359 and second gap 360 may be continuous. The distance of the first gap 359 may vary, such as to have different distance between the first structure 322 and second structure 324 at different positions vertically. The distance of the second gap 360 between the first and second structures 322, 324 may be approximately constant. The second gap 360 may be alternatively referred to and described as an interface, due to how the surface of the second gap 360 may be level and parallel if placed in surface sharing contact. The first structure 322 and second structure 324 may be rotationally coupled and assembled into the shift fork assembly 320 via a spring 326 and a dowel 328. As separate parts, the first structure 322 and second structure 324 may move separate from one another. For example, the second structure 324 may rotate to different positions from the first structure 322, about a common axis shared by the first structure 322 and second structure 324. The common axis may be the third axis 312 of the shift fork assembly 320. The first structure 322 and the second structure 324 may both rotate about the third axis 312 independently of one another. The dowel 328 may be a dowel rod. The dowel 328 may be centered about the third axis 312 when fit to the first structure 322 and second structure 324, such that the centerline of the dowel 328 is collinear with the third axis 312. The spring 326 may be positioned about the third axis 312 and about portions of the first structure 322 and second structure 324.

The first structure 322 may be a collar that couples to components of a complementary clutch assembly, such as a clutch collar. The first collar 252 and/or third collar 256 of FIG. 2 may each be the first structure 322. Likewise, the second structure 324 may be a collar that couples to components of an actuator assembly and therein may be an actuator collar, such as a shift actuator collar. The second collar 254 and/or fourth collar 258 may each be the second structure 324.

The shift fork assembly 320 may comprise a substantially arched-shaped or half-circular member. For example, the first structure 322 may include a first arch 330 comprising a first arm 332 and a second arm 334. The first arm 332 may comprise a first mounting component 336. The second arm 334 may comprise a second mounting component 338. The first mounting component 336 may be rigidly coupled to and continuous with the first structure 322 via the first arm 332. Similarly, the second mounting component 338 may be rigidly coupled to and continuous with the first structure 322 via the second arm 334. The first mounting component 336 and second mounting component 338 may be centered about the fourth axis 314. Components of a clutch assembly may physical couple to the first mounting component 336 and second mounting component 338. The first structure 322 includes a first surface 342. Portions of the first surface 342 may be normal to the first axis 306. The first surface 342 may be continuous with the first arch 330, the first arm 332, and the second arm 334. The first surface 342 may be contiguous with other surfaces of the first structure 322 via smooth curves and bevels.

The first structure 322 may also include features such as a body 340 and a first sleeve 344 that extend in outward directions, such as radial directions, from the first arch 330. A portion of the body 340 may be cylindrical in shape. The body 340 may be a cantilever that may be used as a support or a coupling feature for the first structure 322 and the shift fork assembly 320 as part of a greater assembly. The body 340 may have a fit, where the fit may receive a dowel, such as a dowel rod or a dowel pin. The first structure 322 may pivot about the dowel received by the body 340. The dowel received by the body 340 is a separate dowel from dowel 328. The body 340 may also be an ejector feature for the first structure 322. The first sleeve 344 may be a first cantilever and may extend from the first arm 332 with a first platform 345. The platform 345 may be located below the first sleeve 344, and the platform 345 may extend in an outward direction from the first arm 332 with the first sleeve 344. The platform 345 may have a plurality of surfaces continuous with surfaces of the first sleeve 344. The first sleeve 344 may have an opening, such as a hole, and a passage fit to the dowel 328. The hole or passage of first sleeve 344 complementary to the dowel 328 may be referred to herein as a fit. The first sleeve 344 may be located about the third axis 312. The first sleeve 344 may be centered about the third axis 312, such that the fit of the first sleeve 344 may receive the dowel 328 and be approximately centered about the third axis 312.

The first structure 322 may also include additional features that extend from the first and second mounting components 336, 338. For example, the second mounting component 338 may have coupling component 348 extending outward from a surface of the second mounting component 338. The coupling component 348 may be an appendage and a coupling location, such as a mount, for a target of a position sensor, or another attachment that a target of a position sensor may physically couple to. The coupling component 348 may extend in downward in vertical direction from the bottom of the second mounting component 338, such as with respect to the z axis of the reference axes 301. The coupling component 348 may be an approximately rectangular shaped body, such as a rectangular prism. The coupling component 348 may have a plurality of beveled edges and corners, smoothing the geometric shape of the coupling component 348.

The second structure 324 may include a second arch 351. The second structure 324 may include a second sleeve 346 that is contiguous with the second arch 351 via an offset arm 350. The offset arm 350 may be positioned below the second sleeve 346 and to the side of the second arch 351. The offset arm 350 may have a plurality of surfaces that are continuous with surfaces of the second arch 351. The offset arm 350 may have at least a surface continuous with the second sleeve 346, such as a surface facing the second gap 360. The second sleeve 346 may have an opening, such as a hole, and a passage fit to the dowel 328. The hole or passage of the second sleeve 346 complementary to the dowel 328 may be referred to herein as a fit. The offset arm 350 may have a plurality of surfaces that are contiguous with the second arch 351 and the second sleeve 346. The offset arm 350 may extend downward in a vertical direction from the second sleeve 346.

The second sleeve 346 may receive the dowel 328. The second sleeve 346 may be centered about the third axis 312, such that the fit of the second sleeve 346 may receive the dowel 328 and be approximately centered about the third axis 312. The first sleeve 344 and second sleeve 346 may be aligned when their respective fits are centered about the third axis 312. The dowel 328 may extend through the first sleeve 344 and through the second sleeve 346. The spring 326 may be positioned about and be in surface sharing contact with the first sleeve 344 and second sleeve 346.

The second arch 351 may comprise a first appendage 356 and a second appendage 358. The first appendage 356 and a second appendage 358 may each curve at an angle from and are approximately continuous with the curvature of the second arch 351. The first and second appendages 356, 358 may be arms. The offset arm 350 may rigidly couple or comprise the second appendage 358. Surfaces of the second arch 351 may be continuous with the first and second appendages 356, 358. Surfaces of the offset arm 350 may be contiguous with the first and second appendages 356, 358. The first appendage 356 may comprise a third mounting component 352. The second appendage 358 may comprise a fourth mounting component 354. The third mounting component 352 may be rigidly coupled to the second structure 324 via the first appendage 356. The fourth mounting component 354 may be rigidly coupled to the second structure 324 via the second appendage 358 and the offset arm 350. The second structure 324 may include a clevis, where the clevis includes the first appendage 356, second appendage 358, third mounting component 352, and fourth mounting component 354. The first appendage 356 and the second appendage 358 may be located about the second axis 307. The first appendage 356, and the second appendage 358 may be positioned about a shifting implement, such as shifting implement 224, or another component of an actuator assembly. The third mounting component 352 and the fourth mounting component 354 may be located about the fifth axis 316. The third mounting component 352 and the fourth mounting component 354 may be centered about the fifth axis 316. The third mounting component 352 and fourth mounting component 354 may each be or include a mount for components of an actuator assembly to physically couple thereto.

The first gap 359 and second gap 360 may be positioned between the first structure 322 and the second structure 324. The second gap 360 may be continuous and merge with the volume of the first gap 359. The second gap 360 may extend vertically from the first gap 359 to the first sleeve 344 and second sleeve 346. The second gap 360 may be positioned the first sleeve 344 and the second sleeve 346, such as when the first sleeve 344 and second sleeve 346 are aligned about the third axis 312. The second gap 360 may also be between the platform 345 and portions of the offset arm 350. The first gap 359 may be positioned between the second appendage 358 and portions of the first arm 332. The first gap 359 may be positioned between the fourth mounting component 354 and the first mounting component 336.

The first structure 322 of the shift fork assembly 320 may shiftingly couple to an engaging component of a clutch or clutch assembly, such as the first engaging component 240 or the second engaging component 242 of FIG. 2. For example, a component included by an engaging component, such as a sleeve, may be physically coupled to the first mounting component 336 and/or second mounting component 338. Components may be physically coupled via fastening through fasteners to the first mounting component 336 and/or second mounting component 338. For example, the first mounting component 336 may have a first passage 362 and the second mounting component 338 may have a second passage 364. The first passage 362 and second passage 364 may be complementary to a plurality of fasteners, such as to receive the fasteners. The first passage 362 and second passage 364 may have fastening features, such as threading, that may be complementary to a fastener. The first passage 362 and second passage 364 may be centered about the fourth axis 314. The first passage 362 and second passage 364 may be through passages that extend through the material of the first mounting component 336 and second mounting component 338, respectively. The first passage 362 and second passage 364 may be holes, such as through holes, for the first mounting component 336 and second mounting component 338 respectively.

The second passage 364 may extend from a face 372 to another face or surface on the opposite side of the second mounting component 338. The second mounting component 338 may include the face 372. The face 372 may be contiguous with the second passage 364. The face or surface opposite to face 372 may be on the second side 310. A face with the same dimensions and shape to face 372 may be mirrored on the first mounting component 336 opposite the first axis 306. The face 372 may be approximately flat and normal to the fourth axis 314. A first notch 374 may be positioned between the first arm 332 and first mounting component 336. A second notch 376 may be positioned between the second arm 334 and second mounting component 338. The first notch 374 and second notch 376 may be above the first mounting component 336 and second mounting component 338, respectively.

The fourth passage 368 may extend from a surface 378 to a surface, such as a face, on the opposite side of the fourth mounting component 354. The fourth mounting component 354 includes surface 378. The surface 378 may be contiguous with the fourth passage 368. A surface with the same dimensions and shape to the surface 378 may be mirrored on the third mounting component 352 opposite the second axis 307.

The second structure 324 of shift fork assembly 320, may shiftingly couple to a shifting implement, such as shifting implement 224. For example, a shifting implement or a connector to a shifting implement may be physically coupled to the third mounting component 352 and/or the fourth mounting component 354. Alternatively, a connector or another component of a shift actuator assembly that may be shifted by a shift actuator may physically couple to the third mounting component 352 and/or the fourth mounting component 354. Components may be physically coupled via fastening through fasteners to the third mounting component 352 and/or the fourth mounting component 354. For example, the third mounting component 352 may have a third passage 366 and the fourth mounting component 354 may have a fourth passage 368. The third passage 366 and the fourth passage 368 may be complementary to a plurality of couplings, such as to receive the couplings. The couplings complementary to the third passage 366 and the third mounting component 352 may couple the second structure 324 to an actuator assembly, such that the actuator assembly may move the second structure 324, such as via rotation. Additionally, couplings complementary to the fourth passage 368 and fourth mounting component 354 may couple the second structure to the actuator assembly, such that the actuator assembly may move the second structure 324, such as via rotation. The third passage 366 and fourth passage 368 may have inner surfaces with a low coefficient of friction. For example, the third and fourth passages 366, 368 may be smooth bore. The third passage 366 and fourth passage 368 may be centered about fifth axis 316, such as if the third mounting component 352 and fourth mounting component 354 are centered about the fifth axis 316. The third passage 366 and fourth passage 368 may be through passages that extend through the material of the first mounting component 336 and second mounting component 338, respectively. The third passage 366 and the fourth passage 368 may be holes, such as through holes, for the first mounting component 336 and the second mounting component 338, respectively. The low coefficient of friction of the surfaces of the third passage 366 and/or the fourth passage 368 may allow the second structure 324 to pivot around the fifth axis 316, such as to pivot about a dowel component or a coupling component received via the third passage 366 and/or fourth passage 368, respectively.

For the example in view 300, the first structure 322 may be arranged such that the first arch 330 is positioned at the top and the first mounting component 336 and the second mounting component 338 are positioned near the bottom with respect to the z-axis of the reference axes 301. Likewise, the second structure 324 may be arranged so the second arch 351 and the offset arm 350 are nearest to the top, while the third mounting component 352 and the fourth mounting component 354 are nearest to the bottom, with respect to the z-axis of the reference axes 301. However, it is to be appreciated that the positioning of the first structure 322 and second structure 324 relative to the z-axis are non-limiting, such that the first structure 322 and second structure 324 may be positioned relative to the reference axes 301 to couple a clutch assembly and an actuator assembly, respectively. For example, the first structure 322 may be arranged such that the first arch 330 is positioned near the bottom, and the first mounting component 336 and the second mounting component 338 are positioned near the top, with respect to the z-axis of the reference axes 301. Likewise, the second structure 324 may be arranged so the second arch 351 and the offset arm 350 are nearest to the bottom, while the third mounting component 352 and the fourth mounting component 354 are nearest to the top, with respect to the z-axis of the reference axes 301.

An example of the first structure 322 and the second structure 324 coupled to components of a clutch assembly and an actuator assembly, respectively, is shown in FIG. 8.

Turning to FIG. 4, it shows a second view 400 of the shift fork assembly 320. The second view 400 is a second side view of the shift fork assembly 320. The second view 400 is a lateral view, normal to the third axis 312 and fourth axis 314. The second view 400 shows the shift fork assembly 320 from the first side 308 of FIG. 3.

The second view 400, shows the second structure 324 may be rotated about the dowel 328 such as to pivot in a first direction 412 or a second direction 414. Additionally or alternatively, the first structure 322 may be rotated about the dowel such as to pivot in the first direction 412 or second direction 414. The first direction 412 and second direction 414 may be angular directions, such as a first angular direction and a second angular direction, respectively. The first direction 412 and second direction 414 are opposite to each other across a line 410, e.g., a line A-A. The line 410 may be a center for alignment. The first structure 322 and second structure 324 may be centered on and divided approximately symmetrically by the line 410, such as to be aligned. The second structure 324 may be pivoted in the second direction 414 to be placed in the position shown in the second view 400.

In addition to the third axis 312 and fourth axis 314, the second view 400 shows a sixth axis 422. The sixth axis 422 may be offset from but parallel to the fifth axis 316 of FIG. 3. The second structure 324 may in a position to be aligned with the sixth axis 422, such that the third passage 366 may be approximately centered about the sixth axis 422. By extension, the third mounting component 352 may be about the sixth axis 422, such as to be centered about the sixth axis. Likewise, the fourth mounting component 354 and fourth passage 368 may be about the sixth axis 422, such as to be centered about the sixth axis 422.

The shift fork assembly 320 may have a second surface 442 and a third surface 440. The second surface 442 may be a surface of the first structure 322, and more specifically the second surface 442 may be a surface of the first arch 330. The second surface 442 may be on the opposite side of the first arch 330 from the first surface 342. The second sleeve 346 may include the third surface 440. The third surface 440 may be an outer surface about the second sleeve 346. The third surface 440 may be curved about second sleeve 346 and the third axis 312. The third surface 440 may be cylindrical in shape. The spring 326 may be positioned about the second sleeve 346 such as to have surface sharing contact with the third surface 440. The second sleeve 346 may include a first fit 450. The first fit 450 is an opening, such as a hole, and a passage, that may receive the dowel 328. The first fit 450 may include an inner surface of the second sleeve 346. The inner surface of the second sleeve 346 and first fit 450 may be smooth with a low coefficient of friction, such that the second sleeve 346 may pivot. The dowel 328 may be centered on the third axis 312 such as to be concentric to the first fit 450 and to the spring 326. The first fit 450 may be the second fit of the second sleeve 346 described with respect to FIG. 3 above.

The spring 326 may have an outer surface 446 and an inner surface 448. The spring may have a third gap 444, such as a C-gap. The spring 326 may be a partial cylinder with the third gap 444. As a C-gap, the third gap 444 may give the spring 326 a C-like shape, and therein the spring 326 may be a C-shaped spring. The outer surface 446 and inner surface 448 may be curved, and may curve about the second sleeve 346. The inner surface 448 may abut and have surface sharing contact with the third surface 440. The outer surface 446 may not be continuous about the entirety of spring 326, and the outer surface 446 may terminate at opposite ends of the third gap 444. Likewise, the inner surface 448 may not be continuous about the entirety of spring 326, and the inner surface 448 may terminate at opposite ends of the third gap 444.

The dimensions of the third gap 444 and the mechanical properties of the spring 326 may define the angle at which the second structure 324 may pivot in the first direction 412 or second direction 414 from the first line 410. Additionally or alternatively, the dimensions of the third gap 444 and the mechanical properties of the spring 326 may define the angle at which the first structure 322 may pivot in the first direction 412 or second direction 414 from the first line 410. For example, the second structure 324 may pivot from the first line 410 in the first direction 412 at a first angle 451. Likewise, the second structure 324 may pivot from the first line 410 in the second direction 414 at a second angle 452. For this or another example, the first structure 322 may pivot from the first line 410 in the first direction 412 at the first angle 451. Likewise, first structure 322 may pivot from the first line 410 in the second direction 414 at the second angle 452.

The first angle 451 and second angle 452 may be a first maximum angle and a second maximum angle, respectively, allowed by the spring 326 for the first structure 322 and/or second structure 324 to pivot from the first line 410. The second structure 324 and/or first structure 322 may stop rotating and may be prevented from pivoting to a greater angle than the first angle 451. At the first angle 451, the second structure 324 and/or first structure 322 may have face sharing contact with the spring 326. At the first angle 451, a counter force from the spring 326 may become equal and opposite the force applied from the second structure 324 and/or first structure 322. Likewise, the second structure 324 and/or first structure 322 may stop rotating and may be prevented from pivoting to a greater angle than the second angle 452. At the second angle 452, the second structure 324 and/or first structure 322 may have face sharing contact with the spring 326. At the second angle 452, a counter force from the spring 326 may become equal and opposite the force applied from the second structure 324 and/or first structure 322. Until the counter force, e.g., a spring force, of the spring 326 is equal to an applied force, such as from the shift fork assembly 320, the spring 326 may elastically change shape and dimensions.

The spring 326 may have a clearance 454, where the clearance 454 is the distance of the third gap 444. The spring 326 may be of a first diameter 456 and a second diameter 458. The second structure 324 may have a width 464. The first diameter 456 may be an outer diameter and the second diameter 458 may be an inner diameter. The second sleeve 346 may have a third diameter 460 and a fourth diameter 462. The third diameter 460 may be an outer diameter and the fourth diameter 462 may be an inner diameter for the second sleeve 346. The fourth diameter 462 may also be the diameter of the first fit 450. The fourth diameter 462 may be greater than the diameter of the dowel 328, such that the second structure may be allowed to pivot about the dowel 328. The width 464 is a distance less than the clearance 454. The width 464 may be a maximum width for the second structure 324 for features not included as part of the third mounting component 352, fourth mounting component 354, or the second sleeve 346. For example, the width 464 may be a maximum distance for first appendage 356. The width 464 may also be a maximum width for the second arch 351, the offset arm 350, and the second appendage 358 of FIG. 3. The width 464 may allow the second structure 324 to pivot to positions between the third gap 444. Likewise, other features of the first structure 322, such as the platform 345 of FIG. 3, may be of the width 464 or other widths having a distance less than the clearance 454. The width 464 or the aforementioned other widths may allow first structure 322 to pivot to positions between the third gap 444.

The third mounting component 352 may include a second face 468. The second face 468 may be positioned about the third passage 366. The second face 468 may be contiguous with the other surfaces of the third mounting component 352 and the first appendage 356 via a plurality of curved surfaces, edges, and bevels. The second face 468 may be continuous with the other surfaces of the third mounting component 352 and the first appendage 356 via a plurality of curved surfaces, edges, and bevels.

For an example of an embodiment, the spring 326 allows for the first angle 451 to be 12.6 degrees from the first line 410. An actuator assembly coupled to the second structure 324 may be pivoted a first maximum distance at the first angle 451. For example, the actuator assembly and a complementary actuator may pivot a distance of 53.78 millimeters (mm). Additionally, first structure 322 or second structure 324 may be pivoted at other angles in the first direction 412 that are less than the first angle 451. The other angles may include an angle when the first structure 322 or second structure 324 are in surface sharing contact is made with an edge of the third gap 444 but no elastic change to the dimensions and shape of spring 326 occurs. For this example, the first structure 322 or second structure 324 may be pivoted maximum angle, such as 12 degrees, from the first line 410 in the first direction 412 without causing elastic change in shape to the spring 326.

For this or another example of an embodiment of the spring 326, the spring 326 allows for the second angle 452 to be 12.6 degrees from the first line 410. An actuator assembly coupled to the second structure 324 may be pivoted a second maximum distance at the second angle 452. For example, the actuator assembly and a complementary actuator may be pivoted a distance of 53.78 mm. Additionally, first structure 322 or second structure 324 may be pivoted at other angles in the second direction 414 that are less than the second angle 452. The other angles may include an angle when the first structure 322 or second structure 324 are surface sharing contact is made with an edge of the third gap 444 but no elastic change to the dimensions and shape of spring 326 occurs. For this example, the first structure 322 or second structure 324 may be pivoted maximum angle, such as 12 degrees, from the first line 410 in the second direction 414 without causing elastic change in shape to the spring 326.

Forces transferred the spring 326 may be kept below a threshold, such as to prevent plastic changes in dimension and shape of the spring 326.

The spring 326 may comprise of a material of a high tensile strength and that has appropriate range of pressures where shape and dimensional change may be elastic. For example, the spring 326 may comprise a variant of spring steel, such as 6150 spring steel. The shape and dimensions of the spring 326 may change elastically above a first threshold of force. The change in shape and dimensions of the spring 326 may be elastic below a second threshold of force. Above the second threshold of force the spring 326 a first form of acute or chronic degradation may occur, wherein plastic shape change of the spring 326 may occur. The spring 326 may change shape and dimensions plastically between the second threshold of force and a third threshold of force. The third threshold of force may be a maximum, above which a second form of acute and permanent degradation may occur. For an example, the first threshold of force may be 24.2 newton meters (Nm) from a momentum arm, such as the first structure 322 or second structure 324, or 1686 Newtons (N) from a force (e.g., a gap force) directly to a surface of the third gap 444. For an example embodiment, the spring 326 may be subject to forces greater than the second threshold of force at pressures greater than or equal to yield strength, where the yield strength is at von Mises Stress and/or a max principle stress of the spring 326. For an example embodiment, the spring 326 may have the von Mises Stress of 983 megapascals (MPa) and a max principle stress of 1,100 MPa. For an example embodiment, the spring 326 may be subject to a force above the third threshold of force at pressures greater than or equal to an ultimate tensile strength of the spring 326. The spring 326 may have an ultimate tensile strength of 2342.8 MPA.

The spring 326 may change shape and dimensions elastically. The dimensions of the spring 326 including the clearance 454, the first diameter 456, and the second diameter 458 may be variable. For example, the first diameter 456 may increase or decrease in distance depending on force or lack thereof applied to the spring 326. For example, when the first structure 322 or second structure 324 are positioned at the first angle 451, the clearance 454, the first diameter 456, and the second diameter 458 may be at greater distances than when the first structure 322 and second structure 324 are positioned to be aligned with the line 410. As another example, when the first structure 322 or second structure 324 are positioned at the second angle 452, the clearance 454, the first diameter 456, and the second diameter 458 may be greater distances than when the first structure 322 and second structure 324 are positioned to be aligned with the line 410. When first structure 322 or second structure 324 are positioned to be aligned with the line 410, the clearance 454, the first diameter 456, and the second diameter 458 may each be at a first threshold of distance. Each of the aforementioned first thresholds of distances are minimum values of distance. When first structure 322 or second structure 324 are positioned at the first angle 451 or the second angle 452, the clearance 454, the first diameter 456, and the second diameter 458 may each be at a second threshold of distance. Each of the aforementioned second thresholds of distances are maximum values of distance.

For an example of an embodiment of the spring 326, the first diameter 456 may be a maximum distance at or below the second threshold of force, such as a distance of 35.4 mm. The first diameter 456 may be a minimum distance below the first threshold of force when no elastic shape or dimensional change occurs. For this or another example of an embodiment of the spring 326, the second diameter 458 may be a maximum distance at or below the second threshold of force, such as at a distance of 28.5 mm. The second diameter 458 may be a minimum distance below the first threshold of force when no elastic shape or dimensional change occurs. For this or another example of an embodiment of the spring 326, the clearance 454 may be a minimum distance below the first threshold of force, such as a distance of 12 mm. The application of force above the first threshold of force may apply a distance of deflection to expand the third gap 444 and increase the distance of the clearance 454. The clearance 454 may expand by a maximum deflection, where the maximum deflection is a deflection distance at a threshold of force less than the second threshold of force. A maximum deflection for the clearance 454 may be a distance of 3.23 mm.

Turning now to FIGS. 5A-5B, their features and components may be described collectively herein. FIG. 5A and FIG. 5B show a third view 500 and fourth view 580, respectively, of the shift fork assembly 320. The third view 500 and fourth view 580 are longitudinal views, normal to the second axis 307. The third view 500 and fourth view 580 may be partially transparent views, showing features such as a second fit 530 and the first fit 450 of the first sleeve 344 and second sleeve 346, respectively. The third view 500 and fourth view 580 may be positioned at approximately the same visual reference. The third view 500 shows the shift fork assembly 320 with the spring 326 coupled to the shift fork assembly 320, such that the spring 326 is coupled to and about the first and second sleeves 344, 346. The fourth view 580 shows the shift fork assembly 320 without the spring 326.

The third view 500 and fourth view 580 show the offset arm 350 and the platform 345 have a third face 516 and a fourth face 518, respectively. The third face 516 may be continuous with portions of the arch 351, the first appendage 356, and the second appendage 358. The third face 516 may be contiguous with the fourth mounting component 354. The fourth view 580 shows the third face 516 may be contiguous with surfaces of the second sleeve 346, such as the third surface 440. The fourth face 518 may be contiguous with the first arm 332. The fourth face 518 may be contiguous with surfaces of the first sleeve 344. The third face 516 may make surface sharing contact with the spring 326, such as when the second structure 324 is pivoted to the first angle 451 of FIG. 4. The fourth face 518 may make surface sharing contact with the spring 326, such as when the first structure 322 is pivoted to the first angle 451 of FIG. 4.

The first sleeve 344 may include a fourth surface 528. The fourth face 518 may be contiguous with the fourth surface 528. The fourth surface 528 may be an outer surface about the first sleeve 344. The fourth surface 528 may be curved about the first sleeve 344 and the third axis 312. The fourth surface 528 may be cylindrical in shape. The spring 326 may be positioned about the first sleeve 344 such as to have surface sharing contact with the fourth surface 528. The second sleeve 346 may have a neck 532. The neck 532 may be positioned between the fourth surface 528 and the first arch 330, such as along and with respect to the third axis 312. The neck 532 may be narrower in dimensions than the fourth surface 528. The neck 532 may depress into the second sleeve 346 from the fourth surface 528 and the first arch 330. The neck 532 may be continuous with the fourth face 518, the fourth surface 528, and the first arch 330.

The first sleeve 344 may include a second fit 530. The second fit 530 may receive the dowel 328. The second fit 530 may include an inner surface of the second sleeve 346. The inner surface of the second sleeve and second fit 530 may be smooth with a low coefficient of friction, such that the dowel 328 may move freely and/or the first sleeve 344 may pivot. The second fit 530 may be the first fit of the first sleeve 344 described with respect to FIG. 3 above. The first fit 450 may be a sliding fit and the second fit 530 may be a press fit. As a sliding fit the first fit 450, and by extension the second sleeve 346 and second structure 324, may slide about the dowel 328 and along the third axis 312. The first fit 450 may be a first length 552 and the second fit 530 may be a second length 554. The spring 326 may be a third length 556. The first length 552 may extend through and be the length of the second sleeve 346, making the first fit 450 a through passage, such as a through hole. The second length 554 may extend from the second gap 360 and through a portion of the material of the first arch 330 and the first arm 332. Both the first fit 450 and the second fit 530 may receive the dowel, such as when the first fit 450 and second fit 530 are aligned. The first fit 450 and second fit 530 may be aligned when the centerlines of the first fit 450 and second fit 530 are approximately collinear. The first fit 450 and second fit 530 may be aligned when both are positioned approximately radially about the third axis 312. When the spring 326 is coupled to the first sleeve 344 and second sleeve 346, the third length 556 may be approximately parallel with the first and second lengths 552, 554. For an example embodiment of the spring 326, the third length 556 may be 28 mm.

The third view 500 and fourth view 580 may show additional dimensions of the shift fork assembly 320. The third mounting component 352 and the fourth mounting component 354 may be separated by a distance 538. The curve 355 of the second arch 351 may be a first radius 540. The distance 538 may be greater than the diameter and/or width of a plurality components of an actuator assembly. The distance 538 may be greater than the diameter and/or width of a component or a plurality of components that may couple to the third mounting component 352 and/or fourth mounting component 354. The first radius 540 may be great enough of a distance such that the curve 355 may be positioned about the component or the plurality of components of the actuator assembly.

The first gap 359 comprises a second clearance 542 between the first structure 322 and second structure 324. The second gap 360 comprises a third clearance 544 between the first structure 322 and second structure 324. The fourth view 580 of FIG. 5B shows the second gap 360 may be a distance 582, where the distance 582 may extend from the first gap 359 to the top of the second sleeve 346. The second clearance 542 may be variable such as to change distance. For example, the second clearance 542 may be an approximately constant distance until reaching a first curve 546 of the first platform 345 and a second curve 548 of the offset arm 350. The second clearance 542 may decrease in distance above the start of the first curve 546 and second curve 548. The second clearance 542 may decrease between the first curve 546 and second curve 548 until decreasing to the distance of the third clearance 544 at the start of the second gap 360. The third clearance 544 may be approximately constant from the first gap 359 terminates and to the top of the second sleeve 346 where the second gap 360 terminates. The third clearance 544 may therein be approximately constant at different points along distance 582.

The second gap 360 and the third clearance 544 may be formed between a first surface 562 of the platform 345 and a second surface 564 of the offset arm 350. The first surface 562 and second surface 564 may be parallel. The first surface 562 and second surface 564 may be flat. The first surface 562 and second surface 564 may be normal to the third axis 312. The first surface 562 may be contiguous with the first curve 546. The second surface 564 may be contiguous with the second curve 548.

For an example embodiment of the second structure 324, a branch 570 may connect the arch 351 to the first appendage 356. Surfaces of the arch 351 may be contiguous with the first appendage 356 via the branch 570. The second structure 324 may have a first lobe 572 and second lobe 574. The first lobe 572 may be positioned between the arch 351 and the first appendage 356. The first lobe 572 may be contiguous with and extend from the arch 351, the first appendage 356, and the branch 570. A third notch 576 may be between the first lobe 572 and the third mounting component 352. The third notch 576 may be below the first lobe 572 and above the third mounting component 352. The second lobe 574 may be positioned between the arch 351 and the second appendage 358. The first lobe 572 may be contiguous with and extend from the arch 351, the second appendage 358, and the offset arm 350. A fourth notch 578 may be between the second lobe 574 and the fourth mounting component 354. The fourth notch 578 may be below the second lobe 574 and above the fourth mounting component 354. The first and second lobes 572, 574 may extend in an inward direction toward the second axis 307 from the material of the second structure 324. The first and second lobes 572, 574 may mechanically support the first and second arms 332, 334, respectively, providing increased tensile and compressive strength to the first structure 322. The first and second lobes 572, 574 may collect lubricant, such as oil. If the first structure 322 is oriented such that the first 336 and second 338 are lower than the arch 330 with respect to gravity, the first and second lobes 572, 574 may distribute the lubricant to a component, such as a component of an actuator assembly, coupled to the second structure 324. The first and second lobes 572, 574 may distribute the lubricant to the actuator assembly coupled to the second structure 324 via the third mounting component 352 and fourth mounting component 354, where the arch 351 and the first and second lobes 572, 574 may be located about components of the actuator assembly.

Turning to FIG. 6, it shows a fifth view 600 of the spring 326. The fifth view 600 is a first side view of the spring 326. The fifth view 600 is also a first isolated view of the spring 326, showing the spring 326 isolated from the other components and features of the shift fork assembly 320.

The spring 326 may be centered about an axis 606. The axis 606 may be parallel or collinear with the third axis 312 of FIG. 3. The axis 606 may also be the third axis 312. The spring 326 may be divided into approximately symmetrical halves by a plane 608. The area of the plane 608 may be parallel with the axis 606. The plane 608 may be centered on the axis 606. The plane 608 may divide the spring 326 into a first side 612 and a second side 614.

In addition to the outer surface 446 and inner surface 448, the spring 326 may include a third surface 622. The third surface 622 may extend about the axis 606 and may terminate at edges and surfaces of the third gap 444. The third surface 622 may have a C like shape. The third surface 622 may be defined and shaped by a first edge 624 and a second edge 626. The third surface 622 may be contiguous with the outer surface 446 via the first edge 624. The third surface 622 may be contiguous with the inner surface 448 via the second edge 626. The first edge 624 and second edge 626 may be curved. The first edge 624 may curve with the curvature of the outer surface 446. The second edge 626 may curve with the curvature of the inner surface 448. The spring 326 may include a surface of approximately same dimensions and shape as the third surface 622, where the surface that may be mirrored opposite the third surface 622 across the outer surface 446 and inner surface 448. For example, a third edge 628 may mirror the first edge 624, where the third edge 628 may be opposite the first edge 624 across the outer surface 446. Likewise, a fourth edge 630 may mirror the second edge 626, where the fourth edge 630 may be opposite the second edge 626 across the inner surface 448.

The spring 326 may include an elastic region 632 comprising greater expansion and tension relative to other regions of the spring 326. Opposite to the elastic region 632 from the inner surface 448 and across the material of the spring 326, a region on the outer surface 446 may experience greater expansion and compression relative to the other regions of the spring 326. In other words, a greater degree of bending and other shape change may occur for the spring 326 due to and within the elastic region 632. Likewise, a greater degree of bending and other shape change may occur at the region on the outer surface 446 that is opposite the elastic region 632 through the material of the spring 326. The elastic region 632 is represented schematically with respect to the other components and features of the spring 326. The elastic region 632 may be opposite the axis 606 from the third gap 444.

The third gap 444 may be between a fourth surface 642 and a fifth surface (see fifth surface 744 in FIG. 7). The clearance 454 may extend from the fourth surface 642 to the fifth surface. The fourth surface 642 may be approximately rectangular in shape and may be defined by a plurality of sides in the form of a fifth edge 644, a sixth edge 646, a seventh edge 648, and an eighth edge 650. The fourth surface 642 may be contiguous with the third surface 622 via the fifth edge 644. The third surface 622 and fourth surface 642 may each terminate at the fifth edge 644. The fourth surface 642 may be contiguous with the outer surface 446 via the sixth edge 646. The outer surface 446 and the fourth surface 642 may each terminate at the sixth edge 646. The fourth surface 642 may be contiguous with a surface mirroring the third surface 622 via the seventh edge 648. The fourth surface 642 may terminate at the seventh edge 648. The fourth surface 642 may be contiguous with the inner surface 448 via the eighth edge 650. The inner surface 448 and the fourth surface 642 may terminate at the eighth edge 650.

The fourth surface 642 and fifth surface may be symmetrical to one another. The fifth surface may have approximately the same dimensions and shape as the fourth surface 642, where the fifth surface may be mirrored to the fourth surface 642 opposite the plane 608. The features, such as the edges, of the fourth surface 642 may be mirrored on the fifth surface. For example, a ninth edge 654 may mirror the fifth edge 644. Likewise, the tenth edge 656 may mirror the sixth edge 646.

The spring 326 may contract in a first direction 666 and/or a second direction 668 at the third gap 444. The spring 326 may expand in a third direction 676 and/or a fourth direction 678 at the third gap 444. The first direction 666 and third direction 676 may be approximately normal to the fourth surface 642. The second direction 668 and the fourth direction 678 may be approximately normal to the fifth surface 744. The first direction 666, second direction 668, third direction 676, and fourth direction 678 may be represented schematically as arrows. The expansion of the third gap 444 may increase the clearance 454. Likewise, the expansion of the third gap 444 may expand the first diameter 456 and the second diameter 458.

For example, a first force may be applied normal to the fourth surface 642 in the third direction 676. The first force may be greater than a force of the first threshold, where the first threshold is a threshold of force above which the spring may experience elastic shape change. The first threshold of force is described above with the description of FIG. 4. The application of the first force in the third direction 676 may expand the third gap 444 in the third direction 676, increasing the distance of the clearance 454. If the first force is removed or the first force is reduced to a force less than the first threshold, the third gap 444 may contract in the first direction 666, decreasing the distance of the clearance 454. The first force may be transferred from a component of the shift fork assembly 320, such as the second structure 324, of FIG. 3.

For another example, a second force may be applied normal to the fifth surface 744 in the fourth direction 678. The second force may be greater than a force of the first threshold. The application of the second force in the fourth direction 678 may expand the third gap 444 in the fourth direction 678, increasing the distance of the clearance 454. If the second force is removed or reduced to a force less than the first threshold, the third gap 444 may contract in the second direction 668, decreasing the distance of the clearance 454. The second force may be transferred from a component of the shift fork assembly 320, such as the second structure 324, of FIG. 3.

Turning to FIG. 7, it shows a sixth view 700 of the spring 326 isolated from the other components and features of the shift fork assembly 320. The sixth view 700 is a second side view of the spring 326.

The sixth view 700 shows the spring 326 and the third gap 444 are expanded from an unexpanded state. When the spring 326 is in an unexpanded state, (e.g., when no force is applied to features of the spring 326), the clearance 454 may be a first dimension 722. The first dimension 722 may be a minimum clearance for the third gap 444. In a few examples, the first dimension 722 may be approximately 12 mm. When the spring 326 is in an expanded state, the clearance 454 may be less than or equal to a second dimension 724. The second dimension 724 may be a maximum clearance for the third gap 444. The first dimension 722 and second dimension 724 are represented schematically as double arrowed lines with complementary perpendicular lines representing the termination points of the distance.

The clearance 454 of the third gap 444 may be expanded greater than the first dimension 722 via a first force 738. The first force 738 may be a force greater than the first threshold of force to cause elastic shape change to at the third gap 444. The first force 738 may be normal to the fourth surface 642. The first force 738 is represented schematically as a line with an arrow. The first force 738 may be transferred to the fourth surface 642 from a component of the shift fork assembly 320, such as the second structure 324, of FIG. 3.

The sixth view 700 also shows the fifth surface 744. The fifth surface 744 may share the same dimensions as the fourth surface 642. The fifth surface 744 may mirror the fourth surface 642 opposite the plane 608.

Turning to FIG. 8, it shows a seventh view 800 of an assembly 810. The seventh view 800 is a first sectional view of the assembly 810. The assembly 810 may be part of a larger gear shifting assembly. A line 808 is shown and may divide the assembly 810. A plane taken on the line 808 may be parallel with the fourth axis 314 and the fifth axis 316. A sectional view may be taken on the line 808, such as in FIG. 9 below. The assembly 810 may be housed in a housing 814. The housing 814 may be a housing of a transmission or a gearbox, such as the transmission 108 of FIG. 1. Alternatively, the housing 814 may be a component or feature of the housing of the transmission or the gearbox. The assembly 810 may include a clutch assembly 816 and an actuator assembly 820. The clutch assembly 816 includes a clutch. The clutch assembly 816 may be centered about the first axis 306 (see FIG. 3). The first structure 322 may be positioned about clutch assembly 816. The first arch 330 and the first mounting component 336, and the first arm 332, the second arm 334, and the second mounting component 338 of FIG. 3, may be positioned about the clutch assembly 816. The clutch assembly 816 may be coupled to the first structure 322 via the first mounting component 336 and the second mounting component 338. The clutch assembly 816 may be part of a dog clutch assembly, where the clutch may be a dog clutch, including a dog gear as an engaging component. The actuator assembly 820 may be positioned about the second axis 307. The actuator assembly 820 may be centered about the second axis 307. The actuator assembly 820 may include a shift actuator, such as the actuator 222. The actuator assembly 820 may shiftingly couple to the shift fork assembly 320 via physically coupling to the second structure 324. The actuator assembly 820 may be shiftingly coupled to the second structure 324 via the third mounting component 352 and the fourth mounting component 354. The housing 814 may include a cover 822. The cover 822 may be positioned about a portions of the second structure 324, such as a portion of the second sleeve 346. The cover 822 may be positioned below portions of the second structure 324, such as the second arch 351.

The clutch assembly 816 may shiftingly couple to the first mounting component 336 and second mounting component 338 via at least a coupling, such as a first coupling 832. Couplings, such as the first coupling 832, may be a coupling or coupling device that may shiftingly couple the clutch assembly 816 to structures such as the shift fork assembly 320. The first coupling 832 may shiftingly couple the clutch assembly 816 to the first mounting component 336. The first coupling 832 may be fastened to the first mounting component 336. The first coupling 832 is an engagement device, such as a pad. For example, couplings, such the first coupling 832, that shiftingly couples the first structure 322 to the clutch assembly 816 may be shift pads. The clutch assembly 816 may include a sleeve 834. The sleeve 834 may be centered about the first axis 306. The first coupling 832 may be positioned between the first mounting component 336 and a sleeve 834. The first coupling 832 may be fastened to and be received by the first mounting component 336, such as via the first passage 362. The first coupling 832 may have an appendage 838. The appendage 838 may be complementary and fit to the first passage 362. The appendage 838 and the first passage 362 may have a plurality of smooth surfaces with a low coefficient of friction, where for an example the appendage 838 may be a peg and the first passage 362 may be smooth bore. The smooth surfaces of the appendage 838 and the first passage 362 may allow for the first mounting component 336 to pivot about the appendage 838. The appendage 838 may be fastened to the first mounting component 336 via the first passage 362. The first coupling 832 may have surface sharing contact with features of the sleeve 834. The surfaces of sleeve 834 in surface sharing contact with the first coupling 832 may comprise a first area of contact. The sleeve engagement region may comprise the first area of contact. When in surface sharing contact with the sleeve 834, the first coupling 832 may couple the sleeve 834 to the first structure 322, such that the clutch assembly 816 may be actuated with the shift fork assembly 320.

Additionally, there may be a second coupling that may shiftingly couple the clutch assembly 816 to the first structure 322. For an example of an embodiment, the clutch assembly 816 may be coupled to the first structure 322 via at least a pair of couplings, such as couplings that may be fastened to the first and second mounting components 336, 338. The second coupling may be fastened to and be received by the second mounting component 338, such as via the second passage 364 of FIG. 3. For example, the second coupling may have an appendage that may be complementary and fit to the second passage 364. The appendage of the second coupling and the second passage 364 may have a plurality of smooth surfaces with a low coefficient of friction, where for an example the appendage of the second coupling may be a peg and the second passage 364 may be smooth bore. The smooth surfaces of the appendage of the second coupling and the second passage 364 may allow for second mounting component 338 to pivot about the second appendage. When in surface sharing contact with the sleeve 834, the second coupling may couple the sleeve 834 to the first structure 322, such that the clutch assembly 816 may be actuated with the shift fork assembly 320. The second coupling may be symmetrical to the first coupling 832.

The actuator assembly 820 is sectioned by view 800. The actuator assembly 820 may include a first actuator housing 842 and a sleeve 844. The actuator housing 842 may be positioned about the sleeve 844, such as to be partially around or encircling the sleeve 844. For example, the actuator housing 842 may have portions that may curve around and be positioned radially about the sleeve 844. The actuator housing 842 may comprise a ductile and lighter material, such as aluminum. The sleeve 844 may move linearly with the rotation of the shift implement 846 (e.g., lead screw). A cam shaft coupled to the sleeve 844 may rotate. The actuator assembly 820 may also include a shift implement 846. The shift implement 846 is sectioned by view 800. The actuator assembly 820 may include a coupling 848 that may physically couple to the shift implement 846. The sleeve 844 may be positioned about the coupling 848, such as to be around and/or encircle the coupling 848. The coupling 848 may be positioned about shift implement 846, such as be around and/or encircle the shift implement 846. The shift implement 846 may be the shifting implement 224. As an example the shift implement 846 may be a screw, such as a ball screw. The coupling 848 may be a nut, such as a ball screw nut. A plate 840 may physically couple the actuator housing 842. The plate 840 may physically couple to an extension 849 of the actuator housing 842. The plate 840 may be positioned between the actuator housing 842 and the sleeve 844, such as to be in a location radially between the actuator housing 842 and sleeve 844. The plate 840 may be positioned between the actuator housing 842 and the shift implement 846. The plate 840 may comprise a material of a higher tensile strength than the actuator housing 842, such as steel. The plate 840 may mechanically support the actuator housing 842, including the extension 849, such as when physically coupled to the actuator housing 842. When plate 840 is physically coupled to the actuator housing 842, the plate 840 may reduce wear and other forms of mechanical degradation to the actuator housing 842. Components of the actuator assembly 820 may be coupled, such as physically and/or shiftingly coupled, via a plurality of fasteners, such as a first fastener 850. The first fastener 850 may fasten the plate 840 to the actuator housing 842. For an example embodiment, the first fastener 850 may fasten the plate 840 to the extension 849. The actuator assembly 820 may shiftingly couple to the second structure 324 via a third coupling 852 and a fourth coupling 854. The sleeve 844 may physically couple to the third mounting component 352, such as via fastening by the third coupling 852. The sleeve 844 may physically couple to the fourth mounting component 354, such as via fastening by the fourth coupling 854. The third and fourth couplings 852, 854 may physically couple to the sleeve 844. The third and fourth couplings 852, 854 may be fastened to the third passage 366 and fourth passage 368 of FIG. 3, respectively. The third coupling 852 and the fourth coupling 854 may be symmetrical and the same type of coupling, such that the third coupling 852 and the fourth coupling 854 may be used interchangeably. The third coupling 852 and the fourth coupling 854 may be followers for the sleeve 844, where the third coupling 852 and the fourth coupling 854 may slide or roll within a groove patterned or molded from the sleeve 844.

The third coupling 852 may have a second appendage 856. The fourth coupling 854 may have a third appendage 858. The second appendage 856 may be fit to and received by the third passage 366. The third appendage 858 may be fit to and received by the fourth passage 368. The second and third appendages 856, 858 may extend through the third and fourth passages 366, 368, respectively. The second and third appendages 856, 858 may have smooth outer surfaces with a low coefficient of frictions, such as for example where the second and third appendages 856, 858 may be pegs. Likewise, the third passage 366 and fourth passage 368 may have smooth inner surfaces, such as for example where the third passage 366 and fourth passage 368 were smooth bore. The smooth surfaces of the second appendage 856 and the third passage 366 may allow for the third mounting component 352 to pivot about the second appendage 856. Likewise, the smooth surfaces of the third appendage 858 and the fourth passage 368 may allow for the fourth mounting component 354 to pivot about the third appendage 858. Features such as a clip 860 may fasten the third coupling 852 to the third mounting component 352. The clip 860 may be a retainer ring (e.g., circlip) such as an E clip. The clip 860 may allow the third coupling 852 to spin about the fifth axis 316. The clip 860 may prevent movement, such as sliding, of the third coupling 852 in a direction parallel with the fifth axis 316. The clip 860 may be positioned about and fastened to the second appendage 856 while pressing against the third mounting component 352. Another clip may fasten the fourth coupling 854 to the fourth mounting component 354. For example, the another clip may be positioned about and fastened to the third appendage 858 while pressing against the fourth mounting component 354. The another clip may be a retainer ring, such as an E clip, and may be symmetrical with the clip 860.

Turning to FIG. 9, it shows an eighth view 900 of the assembly 810. The eighth view 900 is a sectional view of the assembly 810 that may be taken on the line 808 of FIG. 8. The eighth view 900 shows an exterior 910. The exterior 910 may represent a volume, such as packing space, about the assembly 810 and housing 814.

The eighth view 900 shows a shaft 912 positioned about an axis 906, such as to be centered around the axis 906. The axis 906 may be parallel with the first axis 306 of FIG. 3. The axis 906 may be collinear with or the first axis 306. The housing 814 may include a wall 914. The wall 914 may be partially cylindrical in shape and curve around the axis 906. The wall 914 is around and include a perimeter surface of a cavity 916. The wall 914 may include a plurality of passages 920. The passages 920 may extend in a direction parallel with the axis 906 through the wall 914. The cavity 916 may house the shift fork assembly 320, the clutch assembly 816, and the shaft 912. The clutch assembly 816 may include a hub 926. The sleeve 834 may be positioned about the hub 926, such as radially about the hub 926. The sleeve 834 be complementary to the hub 926, such as to mesh with the hub 926. The sleeve 834 and hub 926 may mesh via complementary features, such as via teeth of the sleeve 834 and teeth of the hub 926. Both the sleeve 834 and hub 926 may be centered about the axis 906. The clutch assembly 816 may include a plurality of dog teeth 930. The dog teeth 930 may selectively couple sleeve 834 and hub 926 to a complementary rotational element of the clutch assembly 816, where the sleeve 834 and hub 926 may rotationally couple to the complementary component. The cavity 916 may also house a first gear 932, a second gear 934, and a third gear 936.

The first gear 932 may be positioned about the shaft 912, such as to be encircled by or be positioned radially about the shaft 912. The first gear 932 may rotationally couple to the shaft 912. The first gear 932 may be a target gear, where the clutch assembly 816 may selectively couple to the first gear 932. The clutch assembly 816 may selectively couple to the first gear 932 via the sleeve 834. For example, the first gear 932 may rotationally couple to the shaft 912 via selective coupling between the first gear 932 and clutch assembly 816. The clutch assembly 816 may rotationally and physically couple to the shaft 912 via the hub 926. The sleeve 834 may selectively and rotationally couple to the first gear 932 via an engagement feature. The engagement feature may be complementary to the sleeve 834, such as to mesh and selectively couple to the sleeve 834. The engagement feature may rotationally couple to the first gear 932, such as via physically coupling to the first gear 932. The engagement feature may be or include an engagement ring or an engagement collar.

The first gear 932 may mesh with a second gear 934, and the second gear 934 may mesh with a third gear 936. When meshed, the first gear 932 may drivingly couple the second gear 934, such that rotational energy may be transferred between the first gear 932 and second gear 934. The first gear 932 may drive or be driven by the second gear 934. When meshed, the second gear 934 may drivingly couple the third gear 936, such that rotational energy may be transferred the second gear 934 and third gear 936. The second gear 934 may drive or be driven by the third gear 936. The rotational energy transferred between the first gear 932, second gear 934, and third gear 936 may be torque. The first gear 932, second gear 934, and the third gear 936 may be a part of a gear set when meshed.

The cover 822 may include a third fit 942. The third fit 942 may receive the dowel 328 and a first insert 944. The first insert 944 may be cylindrical in shape and hollow, where the cylindrical walls encircle the hollow portion. The first insert 944 may be positioned about the dowel 328, such as to encircle the dowel 328. The first insert 944 may be positioned radially between the third fit 942 and the dowel 328. The first insert 944 may be a bearing or a race that may support and provide the dowel 328 a smooth surface to rotate within the third fit 942.

The wall 914 may include a fourth fit 952, and the body 340 may include a fifth fit 954. The fourth fit 952 may receive a second insert 956. The fifth fit 954 may receive a third insert 960 and the second insert 956. The third insert 960 may be positioned about a dowel section 958 of the second insert 956, such as to encircle the dowel section 958. The third insert 960 may be positioned radially between the fifth fit 954 and the dowel section 958. The third insert 960 may be a bearing or a race that may mechanically support the dowel section 958. The dowel section 958 may be a dowel, such as a dowel pin or a dowel rod. The second insert 956 may be fixed to the housing 814 via the fourth fit 952. The second insert 956 may be removable from fourth fit 952 from the exterior 910. The third insert 960 may have a smooth inner surface, such that fifth fit 954 and third insert 960 may rotate about the dowel section 958. The first structure 322 and the third insert 960 may pivot about the dowel section.

The assembly 810 may have a second coupling 962. The second coupling 962 may shiftingly couple the clutch assembly 816 to the second mounting component 338. The second coupling 962 may be fastened to the second mounting component 338. The second coupling 962 is an engagement device, such as a pad. The second coupling 962 may be positioned between the second mounting component 338 and a sleeve 834. The second coupling 962 may be fastened to the second mounting component 338, such as via the second passage 364. The second coupling 962 may have a second appendage 968. The second appendage 968 may be complementary such as to fit to the second passage 364. The second appendage 968 may be fastened to the second mounting component 338 via the second passage 364. The second coupling 962 may have surface sharing contact with features of the sleeve 834. The surfaces of sleeve 834 in surface sharing contact with the second coupling 962 may comprise a second area of contact. The sleeve engagement region may comprise the second area of contact. When in surface sharing contact with the sleeve 834, the second coupling 962 may couple the sleeve 834 to the first structure 322, such that the clutch assembly 816 may be actuated with the shift fork assembly 320.

The second coupling 962 may have the same dimensions as the first coupling 832. The second coupling 962 may be positioned to mirror the first coupling 832 on the opposite side of the axis 906.

An appendage 972 may physically couple to the coupling component 348, such as to be fixed to the coupling component 348. The appendage 972 may be a mount or a fastener for target. A position sensor may track the target physically coupled to the appendage 972. A target tracked by the position sensor may be used to record or estimate the position of the first structure 322.

It is to be appreciated that the first and second axes 306, 307, and the components, feature, and systems centered about the first and second axes 306, 307, may not be parallel with the y-axis of the reference axes 301. Likewise, it is to be appreciated that the third axis 312, the fourth axis 314, and the fifth axis 316, and the components and systems centered about the aforementioned axes, may not be parallel with the x-axis of the reference axes 301. For an example, the first and second axis 306, 307 are may not be parallel with the y-axis of the reference axes 301. The third axis 312, the fourth axis 314, and the fifth axis 316 may not be parallel with the x-axis of the reference axes 301. The first axis 306, the second axis 307, the third axis 312, the fourth axis 314, and the fifth axis 316 are not parallel or horizontal with respect to the z-axis of the reference axes and the direction of gravity, such that the first axis 306, the second axis 307, the third axis 312, the fourth axis 314, and the fifth axis 316 are diagonal with respect to the z-axis of the reference axes 301 and the direction of gravity. Therefore, component, features, and systems centered on the first axis 306, the second axis 307, the third axis 312, the fourth axis 314, and/or the fifth axis 316 may not be centered on or be parallel with any of the axes of the reference axes 301. Likewise, component, features, and systems centered on the first axis 306, the second axis 307, the third axis 312, the fourth axis 314, and/or the fifth axis 316 and may be diagonal with respect to the z-axis of the reference axes 301 and the direction of gravity.

Turning to FIG. 10, it shows a ninth view 1000 of the actuator assembly 820. The ninth view 1000 is a side view of the actuator assembly 820. The ninth view 1000 shows the actuator assembly 820 separated from other components and features of the assembly 810 of FIG. 8. The actuator assembly 820 may be positioned about the axis 1010, where the actuator assembly 820 may be centered around the axis 1010. The axis 1010 may be a shift axis for the shift implement 846 to be shifted along. The axis 1010 may also be a rotational axis for the shift implement 846 to spin about. The axis 1010 may be parallel with the second axis 307 of FIG. 3. The axis 1010 may be collinear with or may be the second axis 307.

The actuator assembly 820 may have an actuator 1020. The actuator 1020 may drive the shift implement 846 in a first direction 1022 or a second direction 1024 along axis 1010. The first direction 1022 may be opposite to the second direction 1024, and the first direction 1022 and second direction 1024 may be parallel with the axis 1010. The first direction 1022 and second direction 1024 may be represented schematically as arrows with relative positioning. For an example, the shift implement 846 may be screw, e.g., a shift screw. The actuator 1020 may be a motor. The actuator 1020 may be screw actuator, such as a ball screw actuator. The shift implement 846 may have a cover 1032, such as a cap. The cover 1032 may encircle and enclose a portion of the shift implement 846. The cover 1032 may prevent degradation of the shift implement 846, such as from abutting other features of the assembly 810.

The ninth view 1000 shows there may be a plurality of the first fasteners 850, where the first fasteners may fasten the plate 840 to the actuator housing 842. The actuator housing 842 may include a collar 1042. The collar 1042 may be connected to the extension 849 via an arm 1040. The collar 1042 may be positioned about the shift implement 846, such as to encircle and be positioned radially about the shift implement 846.

The collar 1042 may be between the cover 1032 and the sleeve 844 along the axis 1010. The cover 1032 may be in the first direction 1022 from the collar 1042 and the arm 1040. The sleeve 844 may be in the second direction 1024 from the collar 1042 and the arm 1040. When advancing in the first direction 1022, the sleeve 844 may abut the collar 1042. The collar 1042 may stop the sleeve 844 from moving in the first direction 1022 past the collar 1042.

The coupling 848 may include a base 1044. The base 1044 may abut a surface of the sleeve 844, where the surface may be normal to the axis 1010, such as when sleeve 844 encircles the axis 1010.

The collar 1042 may include a groove 1054. The groove 1054 may be patterned to have an L like shape (e.g., an L-shaped groove). A coupling that may couple the collar 1042 to second structure 324 of FIG. 3, such as the third coupling 852 or the fourth coupling 854 of FIG. 8, may be fit to the groove 1054. The couplings that may couple the collar 1042 to the second structure may be followers of the groove 1054. For example, the third coupling 852 and/or the fourth coupling 854 may be followers for the groove 1054. A groove symmetrical with the groove 1054, may mirror and be opposite the axis 1010 from the groove 1054. Likewise, a groove of a different pattern from groove 1054, may be opposite the axis 1010 from the groove 1054. The groove 1054 and the opposite groove may receive couplings that are on opposite arms of the second structure 324. For example, the groove 1054 may receive and fit a portion of the fourth coupling 854, while the groove opposite groove 1054 may receive and fit a portion of the third coupling 852. The portion of the couplings fit to the groove 1054 may be a bearing component, such as a dowel component. The bearing component may be fit to the groove 1054, such that the bearing component of the fastener may rotate within and be shifted by the pattern of the groove 1054. The shifting of the collar 1042 may shift the bearing component and complementary fastener with the pattern of the groove 1054. Therein components complementary to the fasteners, such as the second structure 324, may be shifted and pivoted by the groove 1054. The second structure 324 may be pivoted and shifted via the groove 1054 to engage and disengage the shift fork assembly 320 to different positions.

In this way, a shift fork assembly may engage an engaging component of a clutch and prevent the transfer of force to an actuator assembly. The actuator assembly may shift the shift fork to engage a clutch. The shift fork assembly may include a clutch collar and a shift actuator collar positioned side by side. The clutch collar may couple to one or more engaging components of the clutch. The shift actuator collar may couple to components of the actuator assembly so as to be shifted by the actuator assembly. The clutch collar and the shift actuator collar may be positioned about a dowel centered on a common axis. Likewise, a spring may be positioned about the clutch collar and the shift actuator collar. The clutch collar and the shift actuator collar may rotate independently of one another from torque-driven forces. In some examples, the shift actuator collar may pivot independently of the clutch collar about a common axis. In other examples, both the shift actuator collar and the clutch collar are capable of independent rotation of one another about the common axis. The spring may provide a counter force to forces through the shift fork assembly and may also change shape and dimensions elastically with force. The spring, and independent pivoting of the shift actuator collar from the clutch collar, may prevent rotation forces from being transferred to the actuator assembly. In this way, the disclosed shift fork assembly may reduce acute and chronic degradation to the shifting implement and actuator of the actuator assembly, and reduce service time resulting from degradation and misalignment.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to powertrains that include different types of propulsion sources including different types of prime movers, internal combustion engines, and/or transmissions. The subject matter of the present disclosure includes all novel and non-obvious combinations and sub-combinations of the various systems and configurations, and other features, functions, and/or properties disclosed herein.

Note that the example control and estimation routines included herein can be used with various engine, electric machine, transmission, and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A shift fork assembly comprising:
a clutch collar;
a shift actuator collar positioned side by side to the clutch collar;
a dowel inserted through the clutch collar and the shift actuator collar; and
a C-shaped spring positioned over a first portion of the clutch collar and a second portion of the shift actuator collar, and the dowel being concentric to the C-shaped spring.

2. The shift fork assembly of claim 1, where the shift fork assembly is a rotational shift fork assembly, such that the shift actuator collar rotates independently of the clutch collar.

3. The shift fork assembly of claim 2, where the clutch collar is coupled to a clutch assembly.

4. The shift fork assembly of claim 3, where the clutch collar is a dog clutch collar and the clutch assembly is a dog clutch assembly.

5. The shift fork assembly of claim 3, where the clutch assembly includes an engaging component, where the clutch collar is coupled to the engaging component via at least a mount of the clutch collar and a coupling, where the coupling is fastened to the clutch collar via the mount, where shifting the clutch collar shifts the engaging component to a position.

6. The shift fork assembly of claim 5, where the shift actuator collar is coupled to an actuator assembly, such that shifting the actuator assembly shifts the shift actuator collar and the shift fork assembly.

7. The shift fork assembly of claim 6, where the shift actuator collar has a first maximum angle, where the shift actuator collar is rotated to the first maximum angle in a first angular direction from being parallel with the clutch collar.

8. The shift fork assembly of claim 7, where the shift actuator collar has a second maximum angle, where the shift actuator collar is rotated to the second maximum angle in a second angular direction from being parallel with the clutch collar, where the second angular direction is opposite the first angular direction.

9. The shift fork assembly of claim 8, where the first maximum angle and the second maximum angle are defined by a gap of the C-shaped spring, where the shift actuator collar stops rotating at the first maximum angle from surface sharing contact with a first edge of the gap, where the shift actuator collar stops rotating at the second maximum angle from surface sharing contact with a second edge of the gap.

10. The shift fork assembly of claim 9, where the C-shaped spring is positioned about a first sleeve of the clutch collar and a second sleeve of the shift actuator collar.

11. The shift fork assembly of claim 10, where the first sleeve is the first portion and the second sleeve is the second portion, where the dowel is received by a first complementary fit of the first sleeve and a second complementary fit of the second sleeve, where the first complementary fit and the second complementary fit are centered about a common axis.

12. The shift fork assembly of claim 11, where the clutch collar is positioned about a first axis and the shift actuator collar is positioned about a second axis, where the clutch assembly is centered about the first axis when coupled to the clutch collar, where the actuator assembly is centered about the second axis when coupled to the shift actuator collar.

13. A transmission comprising:
a plurality of gear sets; and
a shift fork assembly configured to shift between gear sets of the transmission, the shift fork assembly including a shift actuator, a first structure, and a second structure that rotate independently of each other, the first structure and the second structure configured to be shifted to a same position by the shift actuator, the first structure coupleable to a component of a clutch and the second structure physically coupleable to the shift actuator, wherein the first structure and the second structure are separated by a first gap and a second gap, the second gap being a clearance allowing for rotation of the second structure independently from the first structure, the first structure and the second structure centered about a common axis.

14. The transmission of claim 13, further comprising a dowel positioned through the first structure and second structure.

15. The transmission of claim 14, wherein the dowel is positioned through a first sleeve of the first structure and a second sleeve of the second structure.

16. The transmission of claim 15, wherein the dowel is centered on the common axis of the first structure and second structure, such that the first structure and second structure pivot about the dowel.

17. The transmission of claim 16, further comprising a spring positioned about portions of the first structure and second structure, and across the first gap.

18. The transmission of claim 17, wherein the spring is C-shaped, the C-shaped spring positioned about the first sleeve and the second sleeve to limit rotation.

19. The transmission of claim 13, wherein the first structure is a clutch collar.

20. The transmission of claim 13, wherein the second structure is an actuator collar.
